(19) United States
(12) Patent Application Publication
(10) Pub. No.: US 2007/0271576 A1
(43) Pub. Date: Nov. 22, 2007

(54) Phase-change optical storage medium

(75) Inventors: Hiroshi Tabata, Ibaraki-Ken (JP); Akihiko Nomura, Kanagawa-Ken (JP); Shinji Higuchi, Ibaraki-Ken (JP)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(73) Assignee: Victor Company of Japan, Ltd., Yokohama-Shi (JP)

(21) Appl. No.: 11/796,013

(22) Filed: Apr. 25, 2007

(30) Foreign Application Priority Data
May 17, 2006 (JP) 2006-137417
Jun. 1, 2006 (JP) 2006-153209

(51) Int. Cl. G11B 7/24

(52) U.S. Cl. 720/719; 428/800

(57) ABSTRACT

An optical storage medium has a substrate having a first surface and a second surface on both sides, the first surface allowing light to pass therethrough in recording or reproduction. The medium also has at least one composite layer having at least a first protective film, a second protective film and a recording film formed in order on the second surface, the first and second protective films exhibiting refractive indices n1 and n2, respectively, having the following relations therebetween, to the light having a specific wavelength λ: n1>n2, n1−n2≧0.02 and 2.1≦n1≦2.5, 1.5≦n2≦2.1. The composite layer may have at least a first protective film, a second protective film, a third protective film and a recording film formed in order on the second surface, the first, second and third protective films exhibiting refractive indices n21, n22 and n23, respectively, having a relation n21>n22>n23 or n22>n21>n23 thereamong, to the light having a specific wavelength λ.

### CROSS-REFERENCE TO RELATED APPLICATIONS

This application is based on and claims the benefit of priority from the prior Japanese Patent Application No. 2006-137417 filed on May 17, 2006 and No. 2006-153209 filed on Jun. 1, 2006, the entire content of which is incorporated herein by reference.

### BACKGROUND OF THE INVENTION

The present invention relates to a phase-change optical storage medium in or from which data is recorded, reproduced or erased with irradiation of a light beam, for example, a laser beam. This invention, particularly, relates to a phase-change optical storage medium, such as, an optical disc, and an optical card that exhibit high reflectivity.

Optical storage media, such as, CD-RW, DVD-RW, DVD-RAM and BD-RE (Blu-ray Disc Rewritable) are a phase-change optical storage medium having a recording layer made of a phase-change material which undergoes reversible change between the crystalline phase and the amorphous phase in recording, reproduction or erasure. Among others, DVD-RW, DVD-RAM and BD-RE are used for recording and rewriting a large capacity of data, such as video data.

Higher storage density could allow recording of a larger amount of data. One option for higher storage density is a multilayer optical storage medium having two or more of data-storage layers, each having a recording film and a reflective film, laminated on one side of a medium substrate.

A data-storage layer located closer to the light-incident surface of such a multilayer optical storage medium requires a certain thickness for feasible recording characteristics for a recording film or a reflective film having a high light absorbancy. This causes difficulty in providing a higher transparency to such a data-storage layer closer to the light-incident medium surface. Difficulty in providing a higher transparency further causes attenuation of an incident laser beam at the closer data-storage layer, which leads to a lower reflectivity at a data-storage layer located farther from the light-incident surface.

Japanese Unexamined Patent Publication No. 2000-322766 discloses a phase-change optical storage medium having a high reflectivity to an incident laser beam at a data-storage layer located farther from the light-incident surface. Laminated in order on a substrate are a first protective film, a second protective film, a third protective film, a fourth protective film, a recording film, a fifth protective film, and a reflective film. The first, second and third protective films are given refractive indices n1, n2 and n3, respectively, with relationships n1>n2 and n3>n2.

The inventors of the present invention, however, found that a phase-change optical storage medium produced as having such relationships n1>n2 and n3>n2 exhibited almost the same reflectivity as a phase-change optical storage medium produced with the same reflective index (n1=n2=n3) for the first, second and third protective films, resulting in almost no enhancement in reflectivity in spite of provision of the three protective films.

As discussed above, a data-storage layer located closer to the light-incident surface more absorbs a laser beam so that a data-storage layer located farther from the light-incident surface exhibits a lower reflectivity, for two or more of data-storage layers formed on a medium surface.

### SUMMARY OF THE INVENTION

A purpose of the present invention is to provide an optical storage medium having two of more of data-storage layers each having a recording film made of a phase-change material in which a data-storage layer located farther from the light-incident surface exhibits a higher reflectivity, with higher productivity.

Another purpose of the present invention is to provide an optical storage medium having at least one data-storage layer having a recording film made of a phase-change material, that exhibits a higher reflectivity.

The present invention provides an optical storage medium comprising: a substrate having a first surface and a second surface on both sides, the first surface allowing light to pass therethrough in recording or reproduction; and at least one composite layer having at least a first protective film, a second protective film and a recording film formed in order on the second surface, the first and second protective films exhibiting refractive indices n1 and n2, respectively, having the following relations therebetween, to the light having a specific wavelength λ: n1>n2 . . . (1), n1−n2≧0.02 . . . (2), and 2.1≦n1≦2.5, 1.5≦n2<2.1 . . . (3).

Moreover, the present invention provides an optical storage medium comprising: a substrate having a first surface and a second surface on both sides, the first surface allowing light to pass therethrough in recording or reproduction; and at least one composite layer having at least a first protective film, a second protective film, a third protective film and a recording film formed in order on the second surface, the first, second and third protective films exhibiting refractive indices n21, n22 and n23, respectively, having either of the following relations thereamong, to the light having a specific wavelength λ: n21>n22>n23 . . . (1) and n22>n21>n23 . . . (2).

### BRIEF DESCRIPTION OF DRAWINGS

FIG. 1 shows an enlarged cross section illustrating an optical storage medium D, a first embodiment of the present invention;

FIG. 2 shows an enlarged cross section illustrating an optical storage medium D20, a second embodiment of the present invention;

FIG. 3 shows TABLE 1 listing several optical characteristics depending on protective-film material measured for embodiment samples E-1 and E-2 and comparative samples C-1 to C-3, in the first embodiment;

FIG. 4 shows TABLE 2 listing several optical characteristics depending on protective-film material measured for the embodiment sample E-1 and embodiment samples E-3 to E-6, and the comparative sample C-1, in the first embodiment;

FIG. 5 shows a graph indicating change in reflectivity at a second composite data-storage layer D2 depending on difference in refractive index (n1−n2), based on the results in TABLE 2, in the first embodiment;

FIG. 6 shows TABLE 3 listing several optical characteristics measured for the embodiment sample E-3 and embodiment samples E-7 to E-9, and comparative samples C-4 to C-7, in the first embodiment;

FIG. 7 shows a graph indicating change in reflectivity at the second composite data-storage layer D2 depending on a ratio of a thickness d2 of a fourth protective film 9 to the total thickness (d1+d2) of third and fourth protective films 8 and 9, in the first embodiment;

FIG. 8 shows TABLE 4 listing several optical characteristics depending on protective-film thickness measured for embodiment samples E-10 to E-21 and comparative samples C-8 to C-23, in the first embodiment;

FIG. 9 shows a graph indicating change in reflectivity at the second composite data-storage layer D2 depending on an optical path length (d1+d2) /λ, based on the results shown in TABLE 4, in the first embodiment;

FIG. 10 shows TABLE 5 listing material, refractive index and sputtering rate for the third and fourth protective films 8 and 9, in the first embodiment;

FIG. 11 shows a graph indicating change in refractive index (n1, n2) depending on a molar ratio α for SiO₂ in ZnS—SiO₂, in the first embodiment;

FIG. 12 shows a graph indicating change in reflectivity at the second composite data-storage layer D2 depending on D2-only reflectivity, in the first embodiment;

FIG. 13 shows TABLE 6 listing several optical characteristics depending on protective-film material measured for embodiment samples E-51 to E-53 and comparative samples C-51 to C-55, in the second embodiment;

FIG. 14 shows TABLE 7 listing several optical characteristics depending on protective-film material measured for embodiment samples E-54 to E-60 and comparative samples C-56 and C-57, in the second embodiment;

FIG. 15 shows a graph indicating change in reflectivity at a second composite data-storage layer D2a depending on difference in refractive index Δn, based on the results in TABLE 7, in the second embodiment;

FIG. 16 shows TABLE 8 listing several optical characteristics depending on protective-film thickness measured for the embodiment sample E-51, embodiment samples E-61 to E-71, and comparative samples C-58 to C-73, in the second embodiment;

FIG. 17 shows change in reflectivity at the second composite data-storage layer D2a depending on an optical path length (d21+d22+d23)/λ, based on the results shown in TABLE 8, in the second embodiment;

FIG. 18 shows change in reflectivity at the second composite data-storage layer D2a depending on D2a-only reflectivity, in the second embodiment;

FIG. 19 shows an enlarged cross section illustrating an optical storage medium Ds, a third embodiment of the present invention; and

FIG. 20 shows an enlarged cross section illustrating an optical storage medium D20a, a fourth embodiment of the present invention.

### DETAILED DESCRIPTION OF PREFERRED EMBODIMENTS

[Structure of Optical Storage Medium]

Representative of phase-change optical storage media having two or more of recording films made of a phase-change material (referred to as a multilayer phase-change optical storage medium, hereinafter) are phase-change optical discs such as DVD-RW, optical cards, and so on, capable of repeatedly overwriting data.

A multilayer optical disc (an optical storage medium) D is described in the following description as embodiments of the present invention. It will, however, be appreciated that the present invention is applicable to other types of multilayer optical storage media having a similar structure.

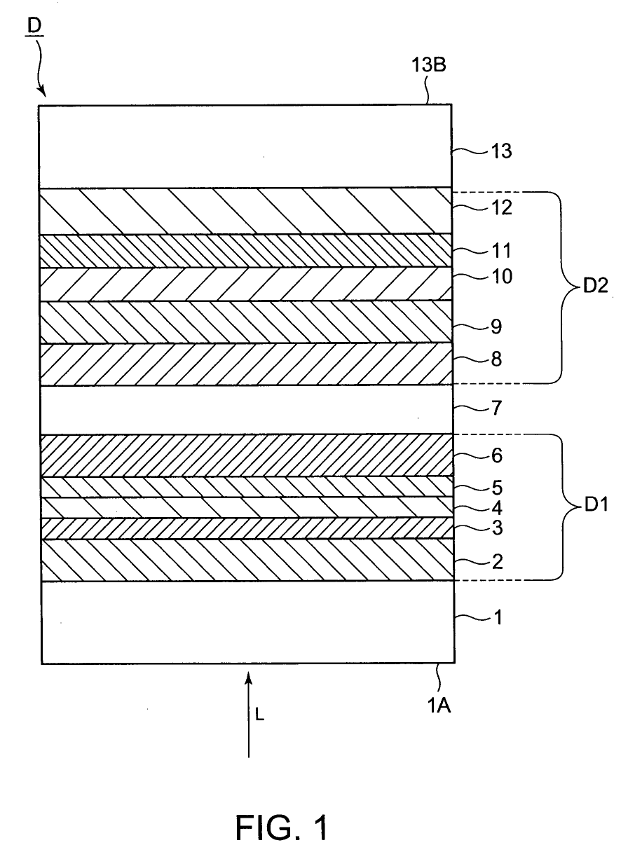

A multilayer optical storage medium D shown in FIG. 1 is a first preferred embodiment of the present invention. The medium D has a first composite data-storage layer D1 and a second composite data-storage layer D2. The first layer D1 is formed on a first substrate 1 having a bottom surface that is a light-incident surface 1A on which a laser beam is incident in a direction L in recording, reproduction or erasure. The second layer D2 is formed on a second substrate 13 having a surface 13B for labeling. The layers D1 and D2 are bonded to each other via an intermediate layer 7.

A layer constituted by a recording film and several kinds of films is referred to as a composite data-storage layer in the following disclosure.

The first composite data-storage layer D1, located closer to the beam-incident surface 1A, has a structure in which a first protective film 2, a semi-transparent first recording film 3, a second protective film 4, a semi-transparent first reflective film 5, and an optical adjustment film 6, laminated in order on the first substrate 1 having the beam-incident surface 1A on the opposite side.

The second composite data-storage layer D2, located farther from the beam-incident surface 1A, has a structure in which a second reflective film 12, a fifth protective film 11, a second recording film 10, a fourth protective film 9, and a third protective film 8, laminated in order on the second substrate 13 having the surface 13B for labeling on the opposite side.

The first and second composite data-storage layers D1 and D2 are bonded with to other via the intermediate layer 7 so that the optical adjustment film 6 of the layer D1 and the third protective film 8 of the layer D2 face with each other.

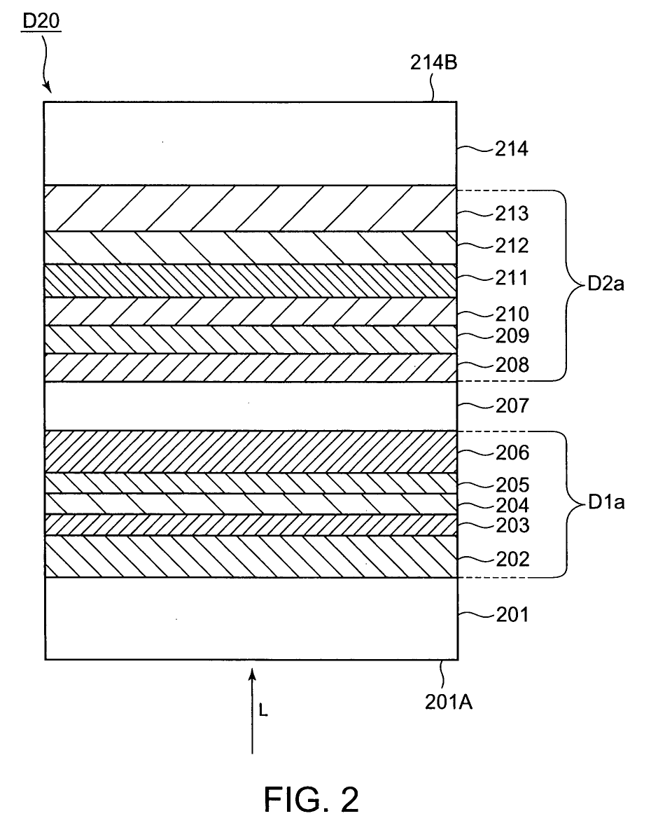

A multilayer optical storage medium D20 shown in FIG. 2 is a second preferred embodiment of the present invention. The medium D20 has a first composite data-storage layer D1a and a second composite data-storage layer D2a. The first layer D1a is formed on a first substrate 201 having a bottom surface that is a light-incident surface 201A on which a laser beam is incident in a direction L in recording, reproduction or erasure. The second layer D2a is formed on a second substrate 214 having a surface 214B for labeling. The layers D1a and D2a are bonded to each other via an intermediate layer 207.

The first composite data-storage layer D1a, located closer to the beam-incident surface 201A, has a structure in which a first protective film 202, a semi-transparent first recording film 203, a second protective film 204, a semi-transparent first reflective film 205, and an optical adjustment film 206, laminated in order on the first substrate 201 having the beam-incident surface 201A on the opposite side.

The second composite data-storage layer D2a, located farther from the beam-incident surface 201A, has a structure in which a second reflective film 213, a sixth protective film 212, a second recording film 211, a fifth protective film 210, a fourth protective film 209, and a third protective film 208, laminated in order on the second substrate 214 having the surface 214B for labeling on the opposite side.

The first and second composite data-storage layers D1a and D2a are bonded to each other via the intermediate layer 207 so that the optical adjustment film 206 of the layer D1a and the third protective film 208 of the layer D2a face with each other.

Suitable materials for the first substrate 1 (201) are several types of transparent synthetic resins, a transparent glass, etc. The material for the first substrate 1 (201) may also be used for the second substrate 13 (214) although the latter needs not be transparent because recording/reproduction to/from the second composite data-storage layer D2 (D20) is performed through the beam-incident surface 1A (201A) via the first composite data-storage layer D1 (D10). Such materials are, for example, glass, polycarbonate, polymethylmethacrylate, polyolefin, epoxy resin, or polyimide. The most suitable material is polycarbonate resin for low birefringence and hygroscopicity, and also easiness to process.

Although not limited, in compatibility with DVD, the thickness of the first substrate 1 (201) and the second substrate 13 (214) is preferably in the range from 0.01 mm to 0.6 mm, particularly, from 0.55 mm to 0.6 mm, for the total DVD thickness of 1.2 mm. This is because dust easily affect recording with a focused laser beam through the light-incident surface 1A (201A) of the first substrate 1 (201) when the thickness of the first substrate 1 (201) is less than 0.01 mm. A practical thickness for the first substrate 1 (201) is in the range from 0.01 mm to 5 mm if there is no particular requirement for the total thickness of the optical storage medium. The thickness of the substrate 1 (201) over 5 mm causes difficulty in increase in objective-lens numerical aperture, which leads to larger laser spot size, hence resulting in difficulty in increase in storage density.

The first substrate 1 (201) and the second substrate 13 (214) may be flexible or rigid. A flexible substrate 1 (201) and second substrate 13 (214) are used for tape-, sheet- or card-type optical storage media whereas a rigid substrate 1 (201) and second substrate 13 (214) are for card- or disc-type optical storage media.

The first protective film 2 (202), the second protective film 4 (204), the third protective film 8 (208), and the fourth protective film 9 (209), the fifth protective film 11 (210), and the sixth protective film 212 (occasionally, referred to as the first to sixth protective films, hereinafter) protect the first substrate 1 (201), the semi-transparent first recording film 3 (203), the second recording film 10 (211), the second substrate 13 (214), etc., from heat which may otherwise cause poor recording characteristics. Moreover, these protective films enhance contrast of signals in reproduction by optical interference.

The material for each of the first to sixth protective films allows a laser beam to pass therethrough in recording, reproduction or erasure and exhibits a refractive index “n”, preferably, in the range of 1.5≦n≦2.3. A suitable material for each of the first to sixth protective films is a material that exhibits high thermal tolerance, for example, an oxide such as SiO₂, SiO, ZnO, TiO₂, Ta₂O₅, Nb₂O₅, ZrO₂ or MgO, a sulfide such as ZnS, In₂S₃ or TaS₄, or carbide such as SiC, TaC, WC or TiC, or a mixture of these materials. Among them, a mixture of ZnS and SiO₂ is the best for high recording sensitivity, C/N and erasing rate against repeated recording, reproduction or erasure. The first to sixth protective films may or may not be made of the same material or composition.

A preferable thickness of the first, third, fourth and fifth protective films 2 (202), 8 (208), 9 (209) and 210 is in the range from about 5 nm to 500 nm. These films preferably give better optical characteristics and cannot be easily peeled off from the first substrate 1 (201), the semi-transparent first recording film 3 (203), the intermediate layer 7 (207) or the second recording film 10 (211) and are not prone to damage such as cracks. In view of these requirements, preferable is in the range from 40 nm to 200 nm for the thickness of the first protective film 2 (202), the total thickness of the third and fourth protective films 8 and 9, and the total thickness of the third, fourth and fifth protective films 208, 209 and 210. The thickness below 40 nm hardly offers good optical characteristics whereas over 200 nm causes proneness to cracks, peeling off, etc, resulting in lower productivity.

The thickness of the second, fifth and sixth protective films 4 (204), 11 and 212 is, preferably, in the range from 0.5 nm to 50 nm for better recording characteristics such as C/N and erasing rate, and also higher stability in a number of repeated overwriting. The thickness below 0.5 nm hardly gives enough heat to the semi-transparent first recording film 3 (203) and the second recording film 10 (211), resulting in increase in optimum recording power for higher C/N and erasing rate, whereas over 50 nm causes lower C/N, erasing rate, etc., in overwriting.

The semi-transparent first recording film 3 (203) and the second recording film 10 (211) are a film of an alloy of: Sb—Te added with at least any one of Ag, Si, Al, Ti, Bi, Ga, In and Ge; Ge—Sb with at least any one of In, Sn and Bi; or Ga—Sb with at least any one of In, Sn and Bi. A preferable thickness range for the recording film 3 (203) is from 3 nm to 15 nm. The thickness below 3 nm lowers a crystallization rate which causes poor recording characteristics whereas over 15 nm lowers light transmittance of the first composite data-storage layer D1 (D1a). A preferable thickness range for the recording film 10 (211) is from 10 nm to 25 nm. The thickness below 10 nm lowers light absorbancy which causes difficulty in heat generation, resulting in poor recording characteristics whereas over 25 nm requires a larger laser power in recording. The recording films 3 (203) and 10 (211) may or may not be made of the same material or composition.

An interface film may be provided on either or each surface of the semi-transparent first recording film 3 (203) and the second recording film 10 (211). One requirement for the interface layer is that it is made of a material without including a sulfide. An interface film made of a material including a sulfide causes diffusion of the sulfide into the recording film 3 (203) or 10 (211) due to repeated overwriting, which could lead to poor recording characteristics.

An acceptable material for the interface film includes at least any one of a nitride, an oxide and a carbide, specifically, germanium nitride, silicon nitride, aluminum nitride, aluminum oxide, zirconium oxide, chromium oxide, silicon carbide and carbon. Oxygen, nitrogen or hydrogen may be added to the material of the interface film. The nitride, oxide and carbide listed above may not be stoichiometric compositions for such an interface film. In other words, nitrogen, oxygen or carbon may be excessive or insufficient.

Preferable materials for the semi-transparent first reflective film 5 (205) and the second reflective film 12 (213) are a reflective metal, such as Al, Au or Ag, an alloy of any of these metals as a major component with at least one type of metal or semiconductor, and a mixture of a metal, such as Al, Au or Ag, and a metal nitride, a metal oxide or a metal chalcogen of Al, Si, etc. In this disclosure, the term “major component” means that the content of a metal, such as Al, Au or Ag in the entire material of the reflective film is over 50%, preferably, over 90%.

Most preferable among them is a metal, such as Au or Ag, or an alloy of any of these metals as a major component, for high reflectivity and thermal conductivity. A typical alloy is made of Al and at least one of the following elements: Si, Mg, Cu, Pd, Ti, Cr, Hf, Ta, Nb, Mn, Zr, etc., or Au or Ag and at least one of the following elements: Cr, Ag, Cu, Pd, Pt, Ni, Nd, etc. For high linear velocity recording, the most preferable one is a metal or an alloy having Ag exhibiting extremely high thermal conductivity as a major component, in view of recording qualities. Especially, Au and Ag that exhibit a lower extinction coefficient for higher light transmittance in recording are the best materials for the semi-transparent first reflective film 5 (205).

Any film that touches the semi-transparent first reflective film 5 (205) or the second reflective film 12 (213) is preferably made of a material without sulfur when the film 5 (205) or 12 (213) is made of pure silver or an alloy of silver, so as not to produce a compound of AgS that leads to higher error rate.

The thickness of the semi-transparent first reflective film 5 (205) is, preferably, in the range from 3 nm to 20 nm, which depends on the thermal conductivity of a material used for this film. The reflective film 5 (205) below 3 nm in thickness cannot absorb heat generated by the semi-transparent first recording film 3 (203), resulting in poor recording characteristics. Thickness over 20 nm causes lower light transmittance for the first composite data-storage layer D1 (D1a).

The thickness of the second reflective film 12 (213) is, preferably, in the range from 50 nm to 300 nm, which depends on the thermal conductivity of a material used for this film. The reflective film 12 (213) of 50 nm or more in thickness is optically stable in, particularly, reflectivity. Nevertheless, a thicker reflective film 12 (213) affects a cooling rate. Thickness over 300 nm requires a longer production time. A material exhibiting a high thermal conductivity allows the reflective film 12 (213) to have a thickness in an optimum range such as mentioned above.

For the multilayer optical storage medium D, a diffusion prevention film (not shown) is, preferably, provided between the second protective film 4 and the semi-transparent first reflective film 5, between the fifth protective film 11 and the second reflective film 12. Such a prevention film is useful when the reflective film 5 and/or 12 are/is made of Ag or an alloy of Ag and the protective film 4 and/or 11 are/is made of a mixture of ZnS. Because the prevention film restricts decrease in reflectivity due to generation of a compound of AgS due to chemical reaction between S in the protective film 4 and/or 11 and Ag in the reflective film 5 and/or 12.

Also, for the multilayer optical storage medium D20, a diffusion prevention film (not shown) is, preferably, provided between the second protective film 204 and the semi-transparent first reflective film 205, and/or between the sixth protective film 212 and the second reflective film 213. Such a prevention film is useful when the reflective film 205 and/or 213 are/is made of Ag or an alloy of Ag and the protective film 204 and/or 212 are/is made of a mixture of ZnS. Because the prevention film restricts decrease in reflectivity due to generation of a compound of AgS due to chemical reaction between S in the protective film 204 and/or 212 and Ag in the reflective film 205 and/or 213.

One requirement for the material of the diffusion prevention film is that it is made of a material without sulfur, like the interface film described above. Preferable materials for the diffusion prevention film are metals, semiconductors, silicon nitride, germanium nitride and germanium chrome nitride, in addition to those the same as the interface film.

Preferable materials for the optical adjustment film 6 (206) are those that exhibit a higher refractive index than the semi-transparent first reflective film 5 (205) and an extinction coefficient smaller than 1, to enhance the light transmittance of the first composite data-storage layer D1 (D1a). The thickness of the film 6 (206) is adjusted so that the layer D1 (D1a) exhibits higher light transmittance in relation to the refractive index of the film 6 (206), wavelength of a laser beam to pass therethrough, etc. A preferable thickness for the film 6 (206) is in the range from 40 nm to 70 nm to a laser wavelength of 660 nm when the film 6 (206) has a refractive index of 2.1.

A preferable material for the optical adjustment film 6 (206) is, for example, Ge, Si or SiH, or a mixture with Ge, Si or SiH as a major component, or an oxide such as SiO₂, SiO, ZnO, TiO₂, Ta₂O₅, Nb₂O₅, ZrO₂, or MgO, a sulfide such as ZnS, In₂S₃ or TaS₄, or carbide such as SiC, TaC, WC or TiC, or a mixture of any of these oxides, sulfides or carbides. Among them, a mixture of ZnS and SiO₂ is the best for higher sputtering rate and thus higher productivity. In this disclosure, the term “major component” means that the content of a material, such as Ge, Si or SiH in the entire material of the optical adjustment film 6 (206) is over 50%, preferably, 90%.

[Optical Storage Medium Production Method]

Lamination of the several films shown in FIG. 1 (2) on the first or the second substrate 1 (201) or 13 (214) is achieved by any known vacuum thin-film forming technique, such as, vacuum deposition (with resistive heating or electron bombardment), ion plating, (D.C., A.C. or reactive) sputtering. The most feasible among the techniques is sputtering for easiness of composition and film-thickness control.

A film-forming system feasible in this method is a batch system in which a plural number of substrates are simultaneously subjected to a film forming process in a vacuum chamber or a single-wafer system in which substrates are processed one by one. The thickness of each film can be adjusted with control of power to be supplied and its duration in sputtering or monitoring conditions of deposited films with a crystal oscillator.

These films can be formed while each substrate is being stationary, transferred or rotating. Rotation of the substrate (and further with orbital motion) is most feasible for higher uniformity. An optional cooling process minimizes warpage of the substrate.

A first production method for producing the optical storage medium D is to: form the first protective film 2, the semi-transparent first recording film 3, the second protective film 4, the semi-transparent first reflective film 5, and the optical adjustment film 6 in order on the first substrate 1 to produce the first composite data-storage layer D1, with the film forming technique described above; form the second reflective film 12, the fifth protective film 11, the second recording film 10, the fourth protective film 9, and the third protective film 8 in order on the second substrate 13 to produce the second composite data-storage layer D2, with the film forming technique described above; and bond the first and second layers D1 and D2 with the intermediate layer 7 made of an adhesive sheet or a UV-curable resin. The layers D1 and D2 may be produced at the same time or either can be produced first.

A second production method for producing the optical storage medium D is to: form the first protective film 2, the semi-transparent first recording film 3, the second protective film 4, the semi-transparent first reflective film 5, and the optical adjustment film 6 in order on the first substrate 1 to produce the first composite data-storage layer D1, with the film forming technique described above; apply a UV-curable resin on the layer D1 (on the film 6); harden or cure the resin with UV rays while a clear stamper (for groove transfer) is being attached on the resin to form the intermediate layer 7; after detaching the stamper, form the third protective film 8, the fourth protective film 9, the second recording film 10, the fifth protective film 11, and second reflective film 12 in order on the intermediate layer 7 to produce the second composite data-storage layer D2, with the film forming technique described above; and bonding the second substrate 13 to the second layer D2 with an adhesive sheet or a UV-curable resin.

The first production method is more feasible than the second production method for higher mass productivity. It is also preferable to produce the optical storage medium D20 according to the first production method.

The optical storage medium D (D20) produced as described above is initialized in such a way that the semi-transparent first recording film 3 (203) and the second recording film 10 (211) are exposed to a laser beam, light of a xenon flash lamp, etc., so that the materials of the films 3 (203) and 10 (211) are heated to be crystallized. Initialization with a laser beam is preferable for less noise in reproduction.

[Study of Refractive Index at Third and Fourth Protective Film]

Several sample optical storage media were produced and evaluated in order to meet the demand for a higher reflectivity at the second composite data-storage layer D2 located farther from the light-incident surface 1A in the optical storage medium D (FIG. 1) of the first embodiment of the present invention.

In detail, embodiment samples E-1 and E-2, and comparative samples C-1, C-2 and C-3 of the optical storage medium D were produced as described below, each with dual films of the third and fourth protective films 8 and 9 next to the second recording film 10 in the second composite data-storage layer D2.

These samples were then evaluated on refractive indices n1 and n2 of the third and fourth protective films 8 and 9, respectively, and also on reflectivity at second composite data-storage layer D2.

The refractive indices n1 and n2 were measured for each sample with a thin film of about 10 nm in thickness formed on a silicon wafer by sputtering, with an ellipsometer (DVA-3613 made by Mizojiri Optical Co. Ltd.) at wavelength λ=660 nm.

Moreover, the reflectivity was measured at the second composite data-storage layer D2 for each sample with an optical-disc drive tester (DDU-1000) equipped with a 660-nm-wavelength laser diode and an optical lens (NA=0.60) made by Pulstec Industrial Co. Ltd.

### Embodiment Sample E-1

Several films which will be disclosed later, were formed on a first substrate 1 made of a polycarbonate resin with 120 mm in diameter and 0.6 mm in thickness. Grooves were formed on the substrate 1 at 0.74 μm in track pitch, with 25 nm in groove depth and about 50:50 in width ratio of groove to land. The grooves stuck out when viewed from an incident direction of a laser beam.

After a vacuum chamber was exhausted up to 3×10⁻⁴ Pa, a 70-nm-thick first protective film 2 was formed on the first substrate 1 by high-frequency magnetron sputtering with a target of ZnS added with 20-mol% SiO₂ at 2×10⁻¹ Pa in Ar-gas atmosphere.

Formed on the first protective film 2, in order, were a 5-nm-thick semi-transparent first recording film 3 with a target of an alloy of Ag—In—Sb—Te, a 10-nm-thick second protective film 4 of the same material as the first protective film 2, a 10-nm-thick semi-transparent first reflective film 5 with a target of an alloy of Ag—Pd—Cu, a 50-nm-thick optical adjustment film 6 of the same material as the first protective film 2, thus the first composite data-storage layer D1 was produced.

Formed on the second substrate 13 produced in the same way as the first substrate 1, in order, with sputtering under the same requirements as the first composite data-storage layer D1, were a 100-nm-thick second reflective film 12 of the same material as the semi-transparent first reflective film 5, a 25-nm-thick fifth protective film 11 of the same material as the first protective film 2, a 20-nm-thick second recording film 10 of the same material as the semi-transparent first recording film 3, a 70-nm-thick fourth protective film 9 with a target of ZnS with SiO₂ added at 40 mol %, and a 70-nm-thick third protective film 8 of the same material as the first protective film 2, thus the second composite data-storage layer D2 was produced.

The optical adjustment film 6 of the first composite data-storage layer D1 was spin-coated with an acrylic UV-curable resin (SD661 made by Dainippon Ink and Chemicals. Inc.). The resin was cured with radiation of UV rays so that a 50-μm-thick intermediate layer 7 was formed on the adjustment film 6. The first and second composite data-storage layers D1 and D2 were bonded to each other so that the adjustment film 6 and the third protective film 8 of the second composite data-storage layer D2 face with each other, thus the embodiment sample E-1 of the optical storage medium D, such as shown in FIG. 1, was produced.

The embodiment sample E-1 was initialized with a wide laser beam having a beam width wider in a direction of tracks than in a direction of radius on the sample to heat the semi-transparent first recording film 3 and the second recording film 10 at a crystallization temperature or higher.

Measured after the initialization was reflectivity at the second composite data-storage layer D2 when the layer D2 was exposed to a laser beam via the first composite data-storage layer D1. The criteria for the reflectivity was that an excellent reflectivity is 5.0% or higher that is the lowest allowable reflectivity to give excellent reproduction.

The refractive index n1 of the third protective film 8 was measured with an ellipsometer for a 100-nm-thick film 8 only formed on a silicon wafer by sputtering, with the same requirements as above. The refractive index n2 of the fourth protective film 9 was measured with an ellipsometer for a 100-nm-thick film 9 only formed on a silicon wafer by sputtering, with the same requirements as above.

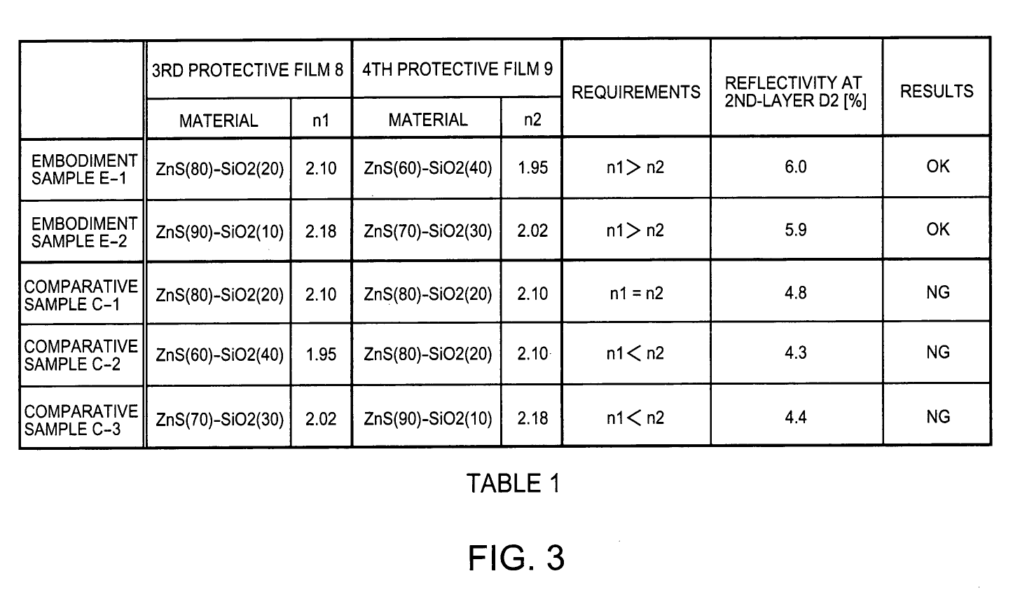

The measured results for the embodiment sample E-1 are listed in TABLE 1 of FIG. 3, together with those for the embodiment sample E-2 and the comparative samples C-1 to C-3. In TABLE 1, the materials of the third and fourth protective films 8 and 9 are indicated as ZnS(80)—SiO₂(20) and ZnS(60)—SiO₂(40), respectively, for the sample E-1, which mean a target of ZnS with SiO₂ added at 20 mol % and 40 mol %, respectively. The same is applied to the other samples.

As shown in TABLE 1, the embodiment sample E-1 exhibited: 2.10 in refractive index n1 at the third protective film 8, and 1.95 in refractive index n2 at the fourth protective film 9, having a relation n1>n2, discussed above; and 6.0% in reflectivity at the second composite data-storage layer D2, beyond 5.0% (the lowest allowable reflectivity), thus excellent (OK) in reflectivity.

### Embodiment Sample E-2

The optical disc D in the embodiment sample E-2 was identical to that of the embodiment sample E-1 except for the third and fourth protective films 8 and 9 formed with a target of ZnS with SiO₂ added at 10 mol % and 30 mol %, respectively.

Measurements in the same way as the embodiment sample E-1 revealed: 2.18 in refractive index n1 at the third protective film 8, and 2.02 in refractive index n2 at the fourth protective film 9, having the relation n1>n2; and 5.9%, excellent in reflectivity at the second composite data-storage layer D2.

### Comparative Sample C-1

The optical disc D in the comparative sample C-1 was identical to that of the embodiment sample E-1 except for the third and fourth protective films 8 and 9 formed with the same material.

Measurements in the same way as the embodiment sample E-1 revealed: 2.10 in refractive index n1 at the third protective film 8, and also 2.10 in refractive index n2 at the fourth protective film 9, having a relation n1=n2; and 4.8% in reflectivity at the second composite data-storage layer D2, bellow 5.0%, thus poor (NG) in reflectivity.

### Comparative Sample C-2

The optical disc D in the comparative sample C-2 was identical to that of the embodiment sample E-1 except for the third and fourth protective films 8 and 9 formed with a target of ZnS with SiO₂ added at 40 mol % and 20 mol %, respectively.

Measurements in the same way as the embodiment sample E-1 revealed: 1.95 in refractive index n1 at the third protective film 8, and also 2.10 in refractive index n2 at the fourth protective film 9, having a relation n1<n2; and 4.3%, poor in reflectivity at the second composite data-storage layer D2.

### Comparative Sample C-3

The optical disc D in the comparative sample C-3 was identical to that of the embodiment sample E-1 except for the third and fourth protective films 8 and 9 formed with a target of ZnS with SiO₂ added at 30 mol % and 10 mol %, respectively.

Measurements in the same way as the embodiment sample E-1 revealed: 2.02 in refractive index n1 at the third protective film 8, and also 2.18 in refractive index n2 at the fourth protective film 9, having the relation n1<n2; and 4.4%, poor in reflectivity at the second composite data-storage layer D2.

The evaluation teaches that the relation n1>n2 for the refractive index n1 at the third protective film 8 and the refractive index n2 at the fourth protective film 9 gives excellent reflectivity to the second composite data-storage layer D2, when the dual films 8 and 9 are provided between the intermediate layer 7 and the second recording film 10 of the layer D2. This is because the third and fourth protective films 8 and 9 are sufficiently thin to 660 nm in wavelength λ used in the measurements so that optical interference between the films enhances a laser beam of 660 nm, in the first embodiment.

The comparative sample C-1 was produced with the third and fourth protective films 8 and 9 formed with the same material, substantially a single protective film, thus could not exhibit an excellent reflectivity at the second composite data-storage layer D2.

The refractive indices n1 and n2 were measured at 660 nm in wavelength λ in the first embodiment. The wavelength λ is, however, not limited to 660 nm. When the optical storage medium D is produced to exhibit the relation n1>n2 to the wavelength λ in the range from 405 nm to 680 nm, a more excellent reflectivity is given to the second composite data-storage layer D2.

[Study of Difference in Refractive Index between Third and Fourth Protective Film]

The inventors of the present invention presupposed that the relation n1>n2 in the refractive indices n1 and n2 of the third and fourth protective films 8 and 9, respectively, could have a specific range for the difference (n1−n2) between the indices, for a more excellent reflectivity to the second composite data-storage layer D2, and found out that the presumption is correct according to the following measurements for the embodiment sample E-1, new embodiment samples E-3, E-4, E-5 and E-6, and the comparative sample C-1.

### Embodiment Sample E-3

The optical disc D in the embodiment sample E-3 was identical to that of the embodiment sample E-1 except for the fourth protective film 9 formed with a target of ZnS with SiO₂ added at 30 mol %.

Measurements in the same way as the embodiment sample E-1 revealed: 2.10 in refractive index n1 at the third protective film 8, and 2.02 in refractive index n2 at the fourth protective film 9; 0.08 in difference of refractive index (n1−n2); and 5.5%, excellent in reflectivity at the second composite data-storage layer D2.

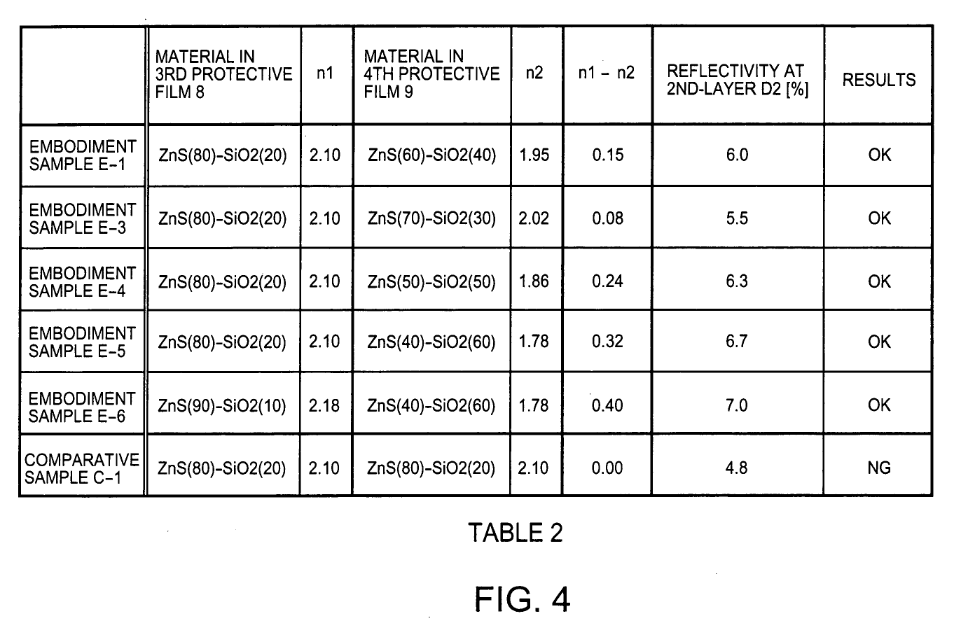

The measured results for the embodiment sample E-3 are listed in TABLE 2 of FIG. 4, together with those for the embodiment samples E-1, E-4 to E-6, and the comparative sample C-1.

### Embodiment Sample E-4

The optical disc D in the embodiment sample E-4 was identical to that of the embodiment sample E-1 except for the fourth protective film 9 formed with a target of ZnS with SiO₂ added at 50mol %.

Measurements in the same way as the embodiment sample E-1 revealed: 2.10 in refractive index n1 at the third protective film 8, and 1.86 in refractive index n2 at the fourth protective film 9; 0.24 in difference of refractive index (n1−n2); and 6.3%, excellent in reflectivity at the second composite data-storage layer D2.

### Embodiment Sample E-5

The optical disc D in the embodiment sample E-5 was identical to that of the embodiment sample E-1 except for the fourth protective film 9 formed with a target of ZnS with SiO₂ added at 60 mol %.

Measurements in the same way as the embodiment sample E-1 revealed: 2.10 in refractive index n1 at the third protective film 8, and 1.78 in refractive index n2 at the fourth protective film 9; 0.32 in difference of refractive index (n1−n2); and 6.7%, excellent in reflectivity at the second composite data-storage layer D2.

### Embodiment Sample E-6

The optical disc D in the embodiment sample E-6 was identical to that of the embodiment sample E-1 except for the third and fourth protective films 8 and 9 formed with a target of ZnS with SiO₂ added at 10 mol % and 60 mol %, respectively.

Measurements in the same way as the embodiment sample E-1 revealed: 2.18 in refractive index n1 at the third protective film 8, and 1.78 in refractive index n2 at the fourth protective film 9; 0.40 in difference of refractive index (n1−n2); and 7.0%, excellent in reflectivity at the second composite data-storage layer D2.

The embodiment sample E-1 and comparative sample C-1 had 0.15 and 0.00, respectively, in difference of refractive index (n1−n2).

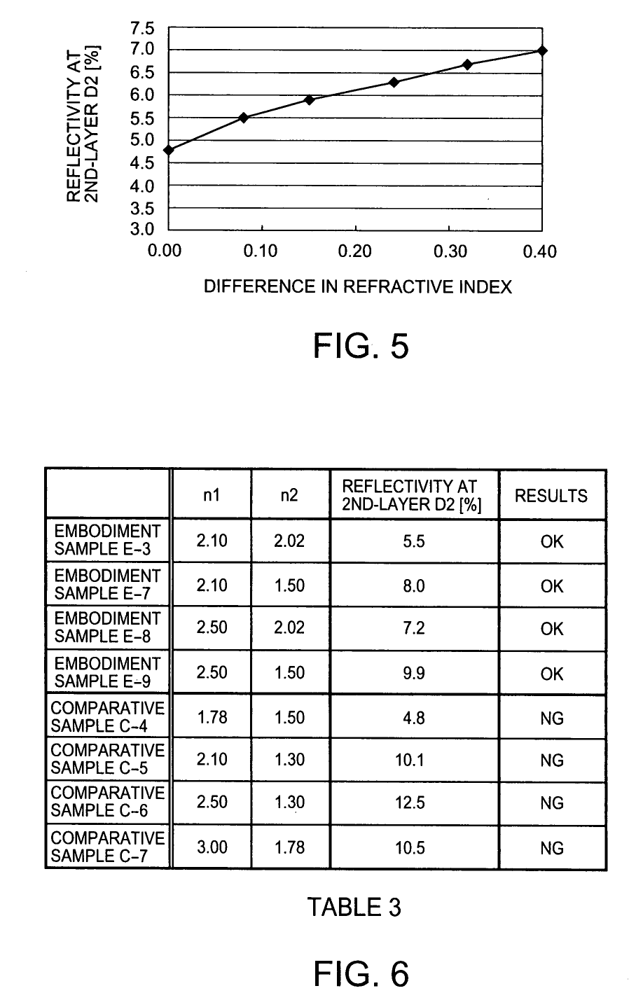

Change in reflectivity at the second composite data-storage layer D2 depending on difference in refractive index (n1−n2) is shown in FIG. 5, based on the results in TABLE 2.

FIG. 5 teaches the difference in refractive index (n1−n2) of 0.02 or larger gives the reflectivity of 5.0% or higher to the second composite data-storage layer D2. A possible reason for this is that 0.02 or larger in (n1−n2) causes optical interference between the third and fourth films 8 and 9 to a laser beam of 660 nm in wavelength λ, thus giving a higher reflectivity to the second composite data-storage layer D2. A difference of 0.08 or larger in refractive index (n1−n2) is feasible in giving an excellent reflectivity for a larger production margin. A more feasible difference in refractive index (n1−n2) is 0.15 or larger that gives a reflectivity of about 6.0% and hence a much larger production margin.

The refractive indices n1 and n2 were also measured at 660 nm in wavelength λ in the embodiment samples E-3 to E-5. The wavelength λ is, however, not limited to 660 nm. When the optical storage medium D is produced to have the difference (n1−n2), as discussed above, to the wavelength λ in the range from 405 nm to 680 nm, a more excellent reflectivity is given to the second composite data-storage layer D2.

[Study of Range of Refractive Index in Third and Fourth Protective Film]

The inventors of the present invention presupposed that each of the refractive indices n1 and n2 of the third and fourth protective films 8 and 9, respectively, could have a specific range for a more excellent reflectivity to the second composite data-storage layer D2, and found out that the presumption is correct according to the following measurements for the embodiment sample E-3, new embodiment samples E-7, E-8 and E-9, and new comparative samples C-4, C-5, C-6 and C-7.

The criteria for the reflectivity was that an excellent reflectivity is 5.0% or higher but 10.0% or lower that are the lowest and the highest allowable reflectivity, respectively, to allow excellent reproduction. A reflectivity over 10.0% could cause misidentification of the type of optical storage media depending on a driver, a recorder, etc.

### Embodiment Sample E-7

The optical disc D in the embodiment sample E-7 was identical to that of the embodiment sample E-1 except for the fourth protective film 9 formed with SiO₂.

Measurements in the same way as the embodiment sample E-1 revealed: 2.10 in refractive index n1 at the third protective film 8, and 2.02 in refractive index n2 at the fourth protective film 9; and 8.0%, excellent in reflectivity at the second composite data-storage layer D2.

The measured results for the embodiment sample E-7 are listed in TABLE 3 of FIG. 6, together with those for the embodiment samples E-3, E-8 and E-9, and the comparative samples C-4 to C-7.

### Embodiment Sample E-8

The optical disc D in the embodiment sample E-8 was identical to that of the embodiment sample E-1 except for the third protective film 8 formed with Nb₂O₅ and the fourth protective film 9 formed with a target of ZnS with SiO₂ added at 30 mol %.

Measurements in the same way as the embodiment sample E-1 revealed: 2.50 in refractive index n1 at the third protective film 8, and 2.02 in refractive index n2 at the fourth protective film 9; and 7.2%, excellent in reflectivity at the second composite data-storage layer D2.

### Embodiment Sample E-9

The optical disc D in the embodiment sample E-9 was identical to that of the embodiment sample E-1 except for the third and fourth protective films 8 and 9 formed with Nb₂O₅ and SiO₂, respectively.

Measurements in the same way as the embodiment sample E-1 revealed: 2.50 in refractive index n1 at the third protective film 8, and 1.50 in refractive index n2 at the fourth protective film 9; and 9.9%, excellent in reflectivity at the second composite data-storage layer D2.

### Comparative Sample C-4

The optical disc D in the comparative sample C-4 was identical to that of the embodiment sample E-1 except for the third protective film 8 formed with a target of ZnS with SiO₂ added at 50 mol % and the fourth protective film 9 formed with SiO₂.

Measurements in the same way as the embodiment sample E-1 revealed: 1.78 in refractive index n1 at the third protective film 8, and also 1.50 in refractive index n2 at the fourth protective film 9; and 4.8%, poor in reflectivity at the second composite data-storage layer D2.

### Comparative Sample C-5

The optical disc D in the comparative sample C-5 was identical to that of the embodiment sample E-1 except for the fourth protective film 9 formed with MgF₂.

Measurements in the same way as the embodiment sample E-1 revealed: 2.10 in refractive index n1 at the third protective film 8, and also 1.30 in refractive index n2 at the fourth protective film 9; and 10.1%, over 10% (the highest allowable reflectivity), thus excessive (NG) in reflectivity at the second composite data-storage layer D2.

### Comparative Sample C-6

The optical disc D in the comparative sample C-6 was identical to that of the embodiment sample E-1 except for the third protective film 8 formed with Nb₂O₅ and the fourth protective film 9 formed with MgF₂.

Measurements in the same way as the embodiment sample E-1 revealed: 2.50 in refractive index n1 at the third protective film 8, and also 1.30 in refractive index n2 at the fourth protective film 9; and 12.5%, excessive in reflectivity at the second composite data-storage layer D2.

### Comparative Sample C-7

The optical disc D in the comparative sample C-7 was identical to that of the embodiment sample E-1 except for the third protective film 8 formed with SiH and the fourth protective film 9 formed with a target of ZnS with SiO₂ added at 50 mol %.

Measurements in the same way as the embodiment sample E-1 revealed: 3.00 in refractive index n1 at the third protective film 8, and also 1.78 in refractive index n2 at the fourth protective film 9; and 10.5%, excessive in reflectivity at the second composite data-storage layer D2.

The evaluation teaches that 2.1≦n1≦2.5 for the refractive index n1 at the third protective film 8 and 1.5≦n2>2.1 for the refractive index n2 at the fourth protective film 9 give an excellent reflectivity to the second composite data-storage layer D2, within the range from 5.0% to 10.0%. The value 2.1 for the refractive index n2 is not shown in TABLE 3, but which is given from TABLE 2.

The refractive indices n1 and n2 were measured at 660 nm in wavelength λ also in these samples. The wavelength λ is, however, not limited to 660 nm. When the optical storage medium D is produced to exhibit the above relations 2.1≦n1≦2.5 and 1.5≦n2<2.1 to the wavelength λ in the range from 405 nm to 680 nm, a more excellent reflectivity is given to the second composite data-storage layer D2.

[Study of Thickness in Third and Fourth Protective Film]

The inventors of the present invention further presupposed that a thickness d1 of the third protective film 8 and a thickness d2 of the fourth protective film 9 could have a specific relation with a wavelength λ of a laser beam in recording, reproduction or erasure, for excellent reflectivity to the second composite data-storage layer D2, and found out a specific range for an optical path length ((d1+d2)/λ), according to the following measurements for new embodiment samples E-10 to E-21, and also new comparative samples C-8 to C-23.

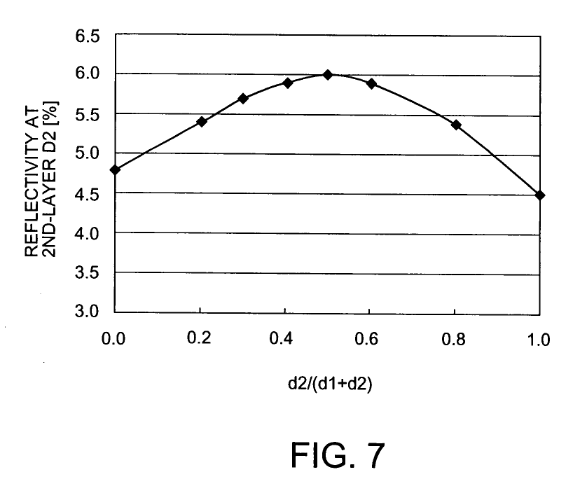

FIG. 7 shows change in reflectivity at the second composite data-storage layer D2 depending on a ratio of the thickness d2 of the fourth protective film 9 to the total thickness (d1+d2) of the third and fourth protective films 8 and 9.

The third and fourth protective films 8 and 9 were formed with a target of ZnS with SiO2 added at 20 mol % and 40 mol %, respectively, for each sample.

FIG. 7 shows that about 50% in ratio of the thickness d2 of the fourth protective film 9 to the total thickness (d1+d2) gives the maximum reflectivity to the second composite data-storage layer D2. Thus, almost equal thickness to the third and fourth protective films 8 and 9 gives an excellent reflectivity to the layer D2.

Accordingly, the following embodiment samples E-10 to E-21 and comparative samples C-8 to C-23 were produced with the third and fourth protective films 8 and 9 at the same thickness.

### Embodiment Sample E-10

The optical disc D in the embodiment sample E-10 was identical to that of the embodiment sample E-1 except for the third protective film 8 having a thickness d1 of 60 nm and the fourth protective film 9 having a thickness d2 of 60 nm.

Measurements in the same way as the embodiment sample E-1 revealed: 2.10 in refractive index n1 at the third protective film 8, and 1.95 in refractive index n2 at the fourth protective film 9; and 5.47%, excellent in reflectivity at the second composite data-storage layer D2.

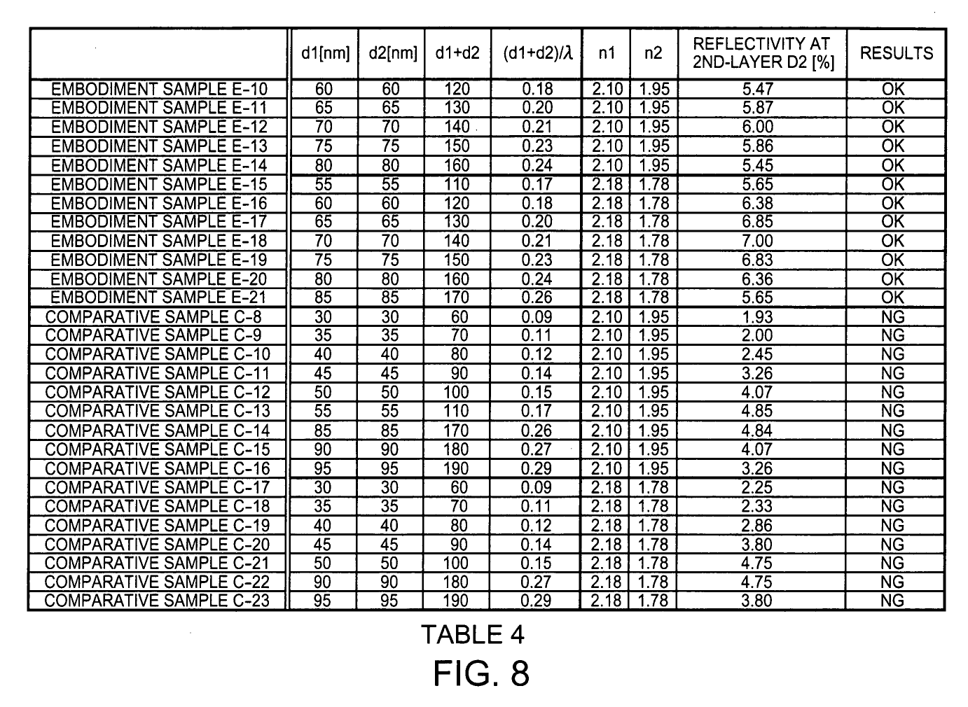

The measured results for the embodiment sample E-10 are listed in TABLE 4 of FIG. 8, together with those for the embodiment samples E-11 to E-21 and the comparative samples C-8 to C-23.

### Embodiment Sample E-11

The optical disc D in the embodiment sample E-11 was identical to that of the embodiment sample E-1 except for the third protective film 8 having a thickness d1 of 65 nm and the fourth protective film 9 having a thickness d2 of 65 nm.

Measurements in the same way as the embodiment sample E-1 revealed: 2.10 in refractive index n1 at the third protective film 8, and 1.95 in refractive index n2 at the fourth protective film 9; and 5.87%, excellent in reflectivity at the second composite data-storage layer D2.

### Embodiment Sample E-12

The optical disc D in the embodiment sample E-12 was identical to that of the embodiment sample E-1 except for the third protective film 8 having a thickness d1 of 70 nm and the fourth protective film 9 having a thickness d2 of 70 nm.

Measurements in the same way as the embodiment sample E-1 revealed: 2.10 in refractive index n1 at the third protective film 8, and 1.95 in refractive index n2 at the fourth protective film 9; and 6.00%, excellent in reflectivity at the second composite data-storage layer D2.

### Embodiment Sample E-13

The optical disc D in the embodiment sample E-13 was identical to that of the embodiment sample E-1 except for the third protective film 8 having a thickness d1 of 75 nm and the fourth protective film 9 having a thickness d2 of 75 nm.

Measurements in the same way as the embodiment sample E-1 revealed: 2.10 in refractive index n1 at the third protective film 8, and 1.95 in refractive index n2 at the fourth protective film 9; and 5.86%, excellent in reflectivity at the second composite data-storage layer D2.

### Embodiment Sample E-14

The optical disc D in the embodiment sample E-14 was identical to that of the embodiment sample E-1 except for the third protective film 8 having a thickness d1 of 80 nm and the fourth protective film 9 having a thickness d2 of 80 nm.

Measurements in the same way as the embodiment sample E-1 revealed: 2.10 in refractive index n1 at the third protective film 8, and 1.95 in refractive index n2 at the fourth protective film 9; and 5.45%, excellent in reflectivity at the second composite data-storage layer D2.

### Embodiment Sample E-15

The optical disc D in the embodiment sample E-15 was identical to that of the embodiment sample E-1 except for the third protective film 8 having a thickness d1 of 55 nm formed with a target of ZnS with SiO₂ added at 10 mol % and the fourth protective film 9 having a thickness d2 of 55 nm formed with a target of ZnS with SiO₂ added at 50 mol %.

Measurements in the same way as the embodiment sample E-1 revealed: 2.18 in refractive index n1 at the third protective film 8, and 1.78 in refractive index n2 at the fourth protective film 9; and 5.65%, excellent in reflectivity at the second composite data-storage layer D2.

### Embodiment Sample E-16

The optical disc D in the embodiment sample E-16 was identical to that of the embodiment sample E-1 except for the third protective film 8 having a thickness d1 of 60 nm and the fourth protective film 9 having a thickness d2 of 60 nm.

Measurements in the same way as the embodiment sample E-1 revealed: 2.18 in refractive index n1 at the third protective film 8, and 1.78 in refractive index n2 at the fourth protective film 9; and 6.38%, excellent in reflectivity at the second composite data-storage layer D2.

### Embodiment Sample E-17

The optical disc D in the embodiment sample E-17 was identical to that of the embodiment sample E-1 except for the third protective film 8 having a thickness d1 of 65 nm and the fourth protective film 9 having a thickness d2 of 65 nm.

Measurements in the same way as the embodiment sample E-1 revealed: 2.18 in refractive index n1 at the third protective film 8, and 1.78 in refractive index n2 at the fourth protective film 9; and 6.85%, excellent in reflectivity at the second composite data-storage layer D2.

### Embodiment Sample E-18

The optical disc D in the embodiment sample E-18 was identical to that of the embodiment sample E-1 except for the third protective film 8 having a thickness d1 of 70 nm and the fourth protective film 9 having a thickness d2 of 70 nm.

Measurements in the same way as the embodiment sample E-1 revealed: 2.18 in refractive index n1 at the third protective film 8, and 1.78 in refractive index n2 at the fourth protective film 9; and 7.00%, excellent in reflectivity at the second composite data-storage layer D2.

### Embodiment Sample E-19

The optical disc D in the embodiment sample E-19 was identical to that of the embodiment sample E-1 except for the third protective film 8 having a thickness d1 of 75 nm and the fourth protective film 9 having a thickness d2 of 75 nm.

Measurements in the same way as the embodiment sample E-1 revealed: 2.18 in refractive index n1 at the third protective film 8, and 1.78 in refractive index n2 at the fourth protective film 9; and 6.83%, excellent in reflectivity at the second composite data-storage layer D2.

### Embodiment Sample E-20

The optical disc D in the embodiment sample E-20 was identical to that of the embodiment sample E-1 except for the third protective film 8 having a thickness d1 of 80 nm and the fourth protective film 9 having a thickness d2 of 80 nm.

Measurements in the same way as the embodiment sample E-1 revealed: 2.18 in refractive index n1 at the third protective film 8, and 1.78 in refractive index n2 at the fourth protective film 9; and 6.36%, excellent in reflectivity at the second composite data-storage layer D2.

### Embodiment Sample E-21

The optical disc D in the embodiment sample E-21 was identical to that of the embodiment sample E-1 except for the third protective film 8 having a thickness d1 of 85 nm and the fourth protective film 9 having a thickness d2 of 85 nm.

Measurements in the same way as the embodiment sample E-1 revealed: 2.18 in refractive index n1 at the third protective film 8, and 1.78 in refractive index n2 at the fourth protective film 9; and 5.65%, excellent in reflectivity at the second composite data-storage layer D2.

### Comparative Sample C-8

The optical disc D in the comparative sample C-8 was identical to that of the embodiment sample E-1 except for the third protective film 8 having a thickness d1 of 30 nm and the fourth protective film 9 having a thickness d2 of 30 nm.

Measurements in the same way as the embodiment sample E-1 revealed 1.93%, poor in reflectivity at the second composite data-storage layer D2.

### Comparative Sample C-9

The optical disc D in the comparative sample C-9 was identical to that of the embodiment sample E-1 except for the third protective film 8 having a thickness d1 of 35 nm and the fourth protective film 9 having a thickness d2 of 35 nm.

Measurements in the same way as the embodiment sample E-1 revealed 2.00%, poor in reflectivity at the second composite data-storage layer D2.

### Comparative Sample C-10

The optical disc D in the comparative sample C-10 was identical to that of the embodiment sample E-1 except for the third protective film 8 having a thickness d1 of 40 nm and the fourth protective film 9 having a thickness d2 of 40 nm.

Measurements in the same way as the embodiment sample E-1 revealed 2.45%, poor in reflectivity at the second composite data-storage layer D2.

### Comparative Sample C-11

The optical disc D in the comparative sample C-11 was identical to that of the embodiment sample E-1 except for the third protective film 8 having a thickness d1 of 45 nm and the fourth protective film 9 having a thickness d2 of 45 nm.

Measurements in the same way as the embodiment sample E-1 revealed 3.26%, poor in reflectivity at the second composite data-storage layer D2.

### Comparative Sample C-12

The optical disc D in the comparative sample C-12 was identical to that of the embodiment sample E-1 except for the third protective film 8 having a thickness d1 of 50 nm and the fourth protective film 9 having a thickness d2 of 50 nm.

Measurements in the same way as the embodiment sample E-1 revealed 4.07%, poor in reflectivity at the second composite data-storage layer D2.

### Comparative Sample C-13

The optical disc D in the comparative sample C-13 was identical to that of the embodiment sample E-1 except for the third protective film 8 having a thickness d1 of 55 nm and the fourth protective film 9 having a thickness d2 of 55 nm.

Measurements in the same way as the embodiment sample E-1 revealed 4.85%, poor in reflectivity at the second composite data-storage layer D2.

### Comparative Sample C-14

The optical disc D in the comparative sample C-14 was identical to that of the embodiment sample E-1 except for the third protective film 8 having a thickness d1 of 85 nm and the fourth protective film 9 having a thickness d2 of 85 nm.

Measurements in the same way as the embodiment sample E-1 revealed 4.84%, poor in reflectivity at the second composite data-storage layer D2.

### Comparative Sample C-15

The optical disc D in the comparative sample C-15 was identical to that of the embodiment sample E-1 except for the third protective film 8 having a thickness d1 of 90 nm and the fourth protective film 9 having a thickness d2 of 90 nm.

Measurements in the same way as the embodiment sample E-1 revealed 4.07%, poor in reflectivity at the second composite data-storage layer D2.

### Comparative Sample C-16

The optical disc D in the comparative sample C-16 was identical to that of the embodiment sample E-1 except for the third protective film 8 having a thickness d1 of 95 nm and the fourth protective film 9 having a thickness d2 of 95 nm.

Measurements in the same way as the embodiment sample E-1 revealed 3.26%, poor in reflectivity at the second composite data-storage layer D2.

### Comparative Sample C-17

The optical disc D in the comparative sample C-17 was identical to that of the embodiment sample E-15 except for the third protective film 8 having a thickness d1 of 30 nm and the fourth protective film 9 having a thickness d2 of 30 nm.

Measurements in the same way as the embodiment sample E-1 revealed 2.25%, poor in reflectivity at the second composite data-storage layer D2.

### Comparative Sample C-18

The optical disc D in the comparative sample C-18 was identical to that of the embodiment sample E-15 except for the third protective film 8 having a thickness d1 of 35 nm and the fourth protective film 9 having a thickness d2 of 35 nm.

Measurements in the same way as the embodiment sample E-1 revealed 2.33%, poor in reflectivity at the second composite data-storage layer D2.

### Comparative Sample C-19

The optical disc D in the comparative sample C-19 was identical to that of the embodiment sample E-15 except for the third protective film 8 having a thickness d1 of 40 nm and the fourth protective film 9 having a thickness d2 of 40 nm.

Measurements in the same way as the embodiment sample E-1 revealed 2.86%, poor in reflectivity at the second composite data-storage layer D2.

### Comparative Sample C-20

The optical disc D in the comparative sample C-20 was identical to that of the embodiment sample E-15 except for the third protective film 8 having a thickness d1 of 45 nm and the fourth protective film 9 having a thickness d2 of 45 nm.

Measurements in the same way as the embodiment sample E-1 revealed 3.80%, poor in reflectivity at the second composite data-storage layer D2.

### Comparative Sample C-21

The optical disc D in the comparative sample C-21 was identical to that of the embodiment sample E-15 except for the third protective film 8 having a thickness d1 of 50 nm and the fourth protective film 9 having a thickness d2 of 50 nm.

Measurements in the same way as the embodiment sample E-1 revealed 4.75%, poor in reflectivity at the second composite data-storage layer D2.

### Comparative Sample C-22

The optical disc D in the comparative sample C-22 was identical to that of the embodiment sample E-15 except for the third protective film 8 having a thickness d1 of 90 nm and the fourth protective film 9 having a thickness d2 of 90 nm.

Measurements in the same way as the embodiment sample E-1 revealed 4.75%, poor in reflectivity at the second composite data-storage layer D2.

### Comparative Sample C-23

The optical disc D in the comparative sample C-23 was identical to that of the embodiment sample E-15 except for the third protective film 8 having a thickness d1 of 95 nm and the fourth protective film 9 having a thickness d2 of 95 nm.

Measurements in the same way as the embodiment sample E-1 revealed 3.80%, poor in reflectivity at the second composite data-storage layer D2.

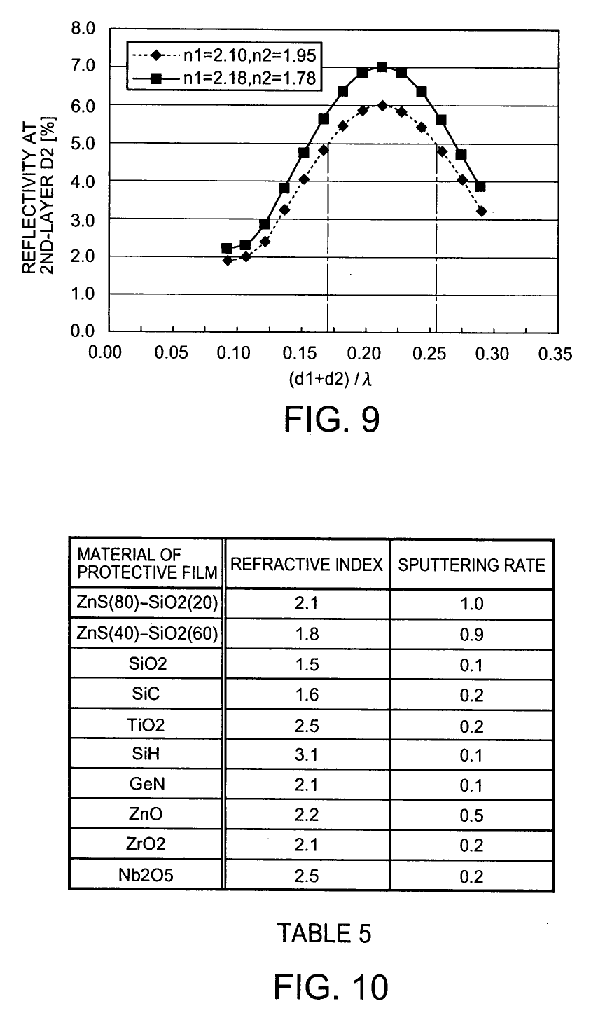

FIG. 9 shows change in reflectivity at the second composite data-storage layer D2 depending the optical path length (d1+d2)/λ, based on the results shown in TABLE 4.

FIG. 9 teaches that the optical storage medium D with the third protective film 8 having the refractive index n1 of 2.10 and the fourth protective film 9 having the refractive index n2 of 1.95 (the embodiment samples E-10 to E-14) exhibits 5.0% or higher in reflectivity at the second composite data-storage layer D2 when the optical path length (d1+d2)/λ is in the range from 0.17 to 0.25.

The comparative samples C-8 to C-13 each with the third protective film 8 having the refractive index n1 of 2.10 and the fourth protective film 9 having the refractive index n2 of 1.95 could have exhibited 5.0% or higher in reflectivity at the second composite data-storage layer D2 if the optical path length (d1+d2)/λ were in the range mentioned above.

FIG. 9 also teaches that the optical storage medium D with the third protective film 8 having the refractive index n1 of 2.18 and the fourth protective film 9 having the refractive index n2 of 1.78 (the embodiment samples E-15 to E-21) exhibits 5.0% or higher in reflectivity at the second composite data-storage layer D2 when the optical path length (d1+d2)/λ is in the range from 0.155 to 0.27.

The comparative samples C-14 to C-23 each with the third protective film 8 having the refractive index n1 of 2.18 and the fourth protective film 9 having the refractive index n2 of 1.78 could have exhibited 5.0% or higher in reflectivity at the second composite data-storage layer D2 if the optical path length (d1+d2)/λ were in the range mentioned above.

Accordingly, in each combination of the refractive indices n1 and n2 described above, the optical path length (d1+d2)/λ in the range from 0.17 to 0.25 gives excellent reflectivity to the second composite data-storage layer D2. A more preferable range is from 0.20 to 0.23 for further excellent reflectivity.

A laser beam of 660 nm in wavelength λ was used in finding the feasible optical path length (d1+d2)/λ that gives excellent reflectivity to the second composite data-storage layer D2, in these samples. The wavelength λ is, however, not limited to 660 nm. When the optical storage medium D is produced to have (d1+d2)/λ in the range from 0.17 to 0.25, a more excellent reflectivity is given to the second composite data-storage layer D2.

TABLE 4 teaches the total thickness (d1+d2) of 110 nm or more for the third and fourth protective films 8 and 9 gives excellent reflectivity to the second composite data-storage layer D2. This is, however, comparatively thick, and hence, a material of a higher sputtering rate is preferable for the films 8 and 9 for higher mass productivity.

Listed in TABLE 5 of FIG. 10 are the material, refractive index and sputtering rate for the third and fourth protective films 8 and 9. Each of the listed sputtering rates except the top-listed is a ratio of the sputtering rate for the corresponding material to 1.0 that is a reference value corresponding to a sputtering rate for the material of ZnS(80)—SiO₂(20), or a target of ZnS with SiO₂ added at 20 mol %. Any value of sputtering rate smaller than 1.0 means that the sputtering rate at the value is slower than that of ZnS(80)13 SiO₂(20).

TABLE 5 teaches a mixture of ZnS and SiO₂, or ZnS—SiO₂ can only be sputtered at a sputtering rate closer 1.0 whereas the other materials (SiO₂, SiC, TiO₂, SiH, GeN, ZnO, ZrO₂, and Nb₂O₃) at much smaller rates, when the sputtering rate of ZnS(80)—SiO₂(20) is defined as 1.0. The materials except ZnS—SiO₂ are thus not useful for mass production due to their slower sputtering rates.

Therefore, the optical storage medium D is required to be produced with ZnS—SiO₂ for the third and fourth protective films 8 and 9 so that the films 8 and 9 exhibit the refractive indices n1 and n2, respectively, having the relation discussed above, for excellent reflectivity at the second composite data-storage layer D2.

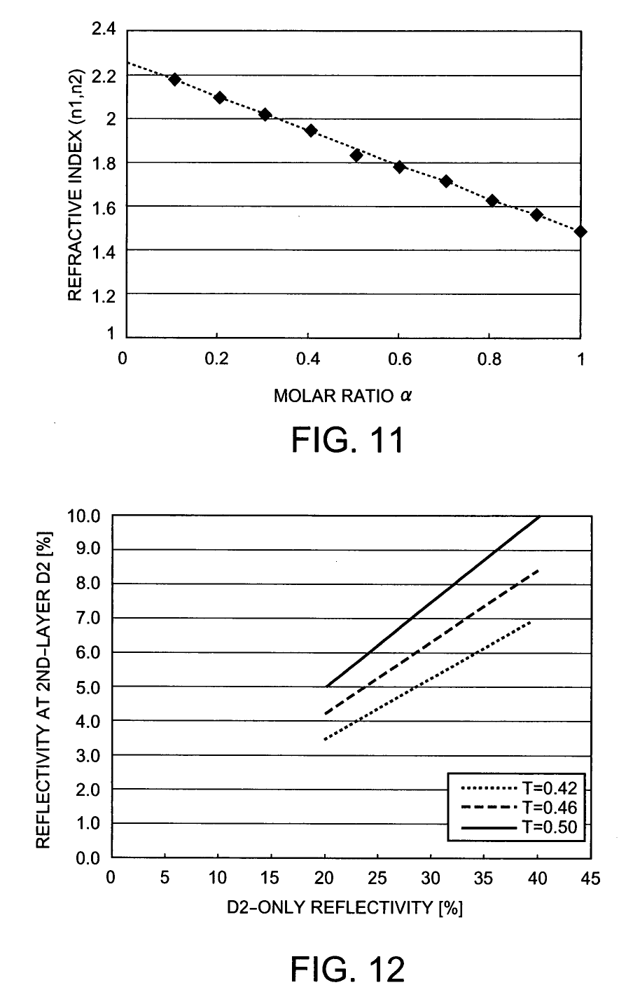

FIG. 11 shows change in refractive index (n1, n2) depending on the molar ratio a for SiO₂ in ZnS—SiO₂, the larger the ratio, the smaller the index.

It is preferable for the third protective film 8 to have a refractive index n1 in the range from 2.1 to 2.5 (2.1≦n1≦2.5), as already discussed. This requirement for the index n1 is satisfied with a molar ratio smaller than 0.2 for SiO₂, according to FIG. 11. In other words, FIG. 11 teaches that ZnS with SiO₂ at a molar ratio of 0, or ZnS only can be used for the third protective film 8 to have a refractive index n1 in the range described above.

It is also preferable for the fourth protective film 9 to have a refractive index n2 in the range from 1.5 to 2.1 (1.5≦n2≦2.1), as already discussed. This requirement for the index n2 is satisfied with a molar ratio in the range from 0.3 to 0.9 for SiO₂, according to FIG. 11. Nevertheless, a molar ratio of SiO₂ over 0.8 causes a slower sputtering rate, thus not feasible in mass production.

Accordingly, higher reflectivity is given to the second composite data-storage layer D2 when the third protective film 8 is formed with a material including at least ZnS, optionally with SiO₂ at a molar ratio al of 0<α1≦0.2 and the fourth protective film 9 with a material including at least ZnS and SiO₂ with a molar ratio α2 of 0.3≦α2≦0.8 for SiO₂.

FIG. 12 shows change in reflectivity at the second composite data-storage layer D2 depending on D2-only reflectivity. The D2-only reflectivity is the reflectivity at the layer D2 provided between the first and second substrates 1 and 13 with no first composite data-storage layer D1 and intermediate layer 7 between the substrate 1 and the layer D2, in the optical storage medium D shown in FIG. 1.

The several films of the second composite data-storage layer D2 were modified so that the layer D2 exhibited different light transmittances T (0.42, 0.46, and 0.50). The D2-only reflectivity was increased at each transmittance T and measured by an optical-disc drive tester (DDU-1000) made by Pulstec Industrial Co. Ltd.

Sample optical storage media D (the first embodiment) were produced with the modified second composite data-storage layers D2 that exhibited the light transmittances T (0.42, 0.46, and 0.50).

The first composite data-storage layer D1 in the first embodiment exhibits about 0.43 in transmittance T to a laser beam having a wavelength λ of 660 nm.

FIG. 12 shows that the modified second composite data-storage layers D2 exhibited the reflectivity of 5.0% or higher to the D2-only reflectivity of 28.0% or higher, at the corresponding transmittances T (0.42, 0.46, and 0.50).

Accordingly, a preferable reflectivity is 28.0% or higher for the second composite data-storage layer D2 located farther from the beam-incident surface 1A, in the optical storage media D of the first embodiment.

Discussed next are the studies for the optical storage medium D20 of the second embodiment of the present invention, similar to those discussed above for the first embodiment. [Study of Refractive Index at Third, Fourth and Fifth Protective Film]

Several sample optical storage media were produced and evaluated in order to meet the demand for a higher reflectivity at the second composite data-storage layer D2a located farther from the light-incident surface 201A in the optical storage medium D20 (FIG. 2) of the second embodiment of the present invention.

In detail, embodiment samples E-51 to E-53, and comparative samples C-51 to C-55 of the optical storage medium D20 were produced as described below, each with triple films of the third, fourth and fifth protective films 208, 209 and 210 between the intermediate layer 207 and the second recording film 211 of the second composite data-storage layer D2a.

These samples were then evaluated on refractive indices n21, n22 and n23 of the third, fourth and fifth protective films 208, 209 and 210, respectively, and also on reflectivity at second composite data-storage layer D2a.

The refractive indices n21, n22 and n23 and the reflectivity were measured for each sample with the same measuring equipment as used in the first embodiment.

### Embodiment Sample E-51

Several films which will be disclosed later, were formed on a first substrate 201 made of a polycarbonate resin with 120 mm in diameter and 0.6 mm in thickness. Grooves were formed on the substrate 201 t 0.74 μm in track pitch, with 25 nm in groove depth and about 50:50 in width ratio of groove to land. The grooves stuck out when viewed from an incident direction of a laser beam.

After a vacuum chamber was exhausted up to 3×10⁻⁴ Pa, a 70-nm-thick first protective film 202 was formed on the first substrate 201 by high-frequency magnetron sputtering with a target of ZnS added with 20-mol % SiO₂ at 2×10⁻¹ Pa in Ar-gas atmosphere.

Formed on the first protective film 202, in order, were a 5-nm-thick semi-transparent first recording film 203 with a target of an alloy of Ag—In—Sb—Te, a 10-nm-thick second protective film 204 of the same material as the first protective film 202, a 10-nm-thick semi-transparent first reflective film 205 with a target of an alloy of Ag—Pd—Cu, a 50-nm-thick optical adjustment film 206 of the same material as the first protective film 202, thus the first composite data-storage layer D1a was produced.

Formed on the second substrate 214 produced in the same way as the first substrate 201, in order, with sputtering under the same requirements as the first composite data-storage layer D1a, were a 100-nm-thick second reflective film 213 of the same material as the semi-transparent first reflective film 205, a 25-nm-thick sixth protective film 212 of the same material as the first protective film 202, a 20-nm-thick second recording film 211 of the same material as the semi-transparent first recording film 203, a 47-nm-thick fifth protective film 210 with a target of ZnS with SiO₂ added at 60 mol %, a 47-nm-thick fourth protective film 209 with a target of ZnS with SiO₂ added at 40 mol %, and a 47-nm-thick third protective film 208 of the same material as the first protective film 202, thus the second composite data-storage layer D2a was produced.

The optical adjustment film 206 of the first composite data-storage layer D1a was spin-coated with an acrylic UV-curable resin (SD661 made by Dainippon Ink and Chemicals. Inc.). The resin was cured with radiation of UV rays so that a 50-μm-thick intermediate layer 207 was formed on the adjustment film 206. The first and second composite data-storage layers D1a and D2a were bonded to each other so that the adjustment film 206 and the third protective film 208 of the second composite data-storage layer D2a face with each other, thus the embodiment sample E-51 of the optical storage medium D20, such as shown in FIG. 2, was produced.

The embodiment sample E-51 was initialized with a wide laser beam having a beam width wider in a direction of tracks than in a direction of radius on the sample to heat the semi-transparent first recording film 203 and the second recording film 211 at a crystallization temperature or higher.

Measured after the initialization was reflectivity at the second composite data-storage layer D2a when the layer D2a was exposed to a laser beam via the first composite data-storage layer D1a. The criteria for the reflectivity was that an excellent reflectivity is 5.0% or higher that is the lowest allowable reflectivity to give excellent reproduction.

The refractive index n21 of the third protective film 208 was measured with an ellipsometer for a 100-nm-thick film 208 only formed on a silicon wafer by sputtering, with the same requirements as above. The refractive index n22 of the fourth protective film 209 was measured with an ellipsometer for a 100-nm-thick film 209 only formed on a silicon wafer by sputtering, with the same requirements as above. Moreover, the refractive index n23 of the fifth protective film 210 was measured with an ellipsometer for a 100-nm-thick film 209 only formed on a silicon wafer by sputtering, with the same requirements as above.

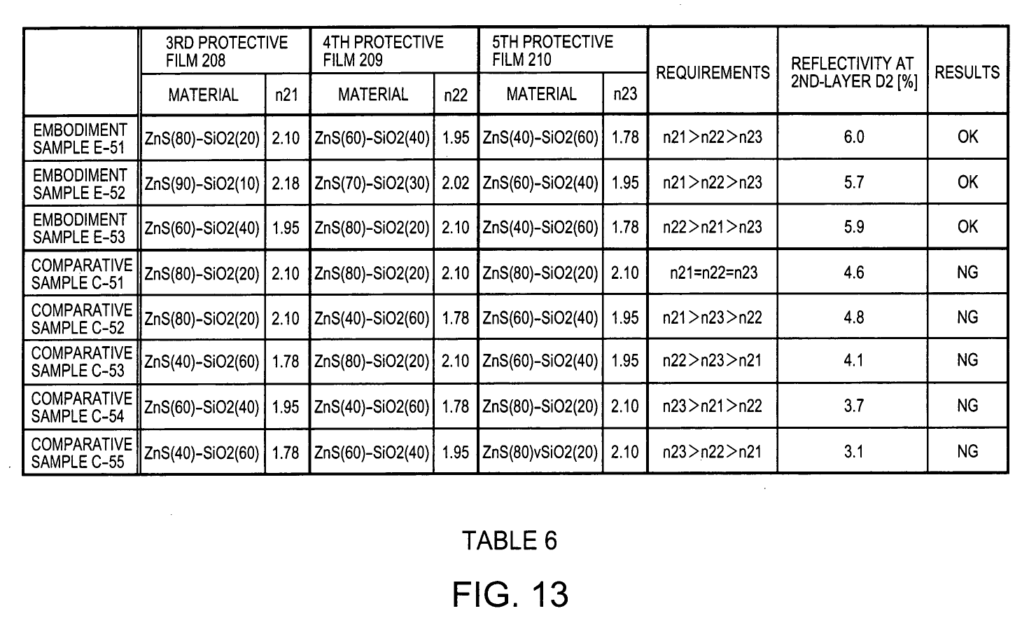

The measured results for the embodiment sample E-51 are listed in TABLE 6 of FIG. 13, together with those for the embodiment samples E-52 and E-53 and the comparative samples C-51 to C-55. In TABLE 6, the materials of the third, fourth and fifth protective films 208, 209 and 210 are indicated as ZnS(80)—SiO₂(20), ZnS(60)—SiO₂(40) and ZnS(40)—SiO₂(60), respectively, for the sample E-51, which mean a target of ZnS with SiO₂ added at 20 mol %, 40 mol % and 60 mol %, respectively. The same is applied to the other samples.

As shown in TABLE 6, the embodiment sample E-51 exhibited: 2.10 in refractive index n21 at the third protective film 208, 1.95 in refractive index n22 at the fourth protective film 209, and 1.78 in refractive index n23 at the fifth protective film 210, having a relation n21>n22>n23; and 6.0% in reflectivity at the second composite data-storage layer D2a, beyond 5.0% (the lowest allowable reflectivity), excellent in reflectivity.

### Embodiment Sample E-52

The optical disc D20 in the embodiment sample E-52 was identical to that of the embodiment sample E-51 except for the third, fourth and fifth protective films 208, 209 and 210 formed with a target of ZnS with SiO2 added at 10 mol %, 30 mol % and 40 mol %, respectively.

Measurements in the same way as the embodiment sample E-51 revealed: 2.18 in refractive index n21 at the third protective film 208, 2.02 in refractive index n22 at the fourth protective film 209, and 1.95 in refractive index n23 at the fifth protective film 210, having the relation n21>n22>n23; and 5.7%, excellent in reflectivity at the second composite data-storage layer D2a.

### Embodiment Sample E-53

The optical disc D20 in the embodiment sample E-53 was identical to that of the embodiment sample E-51 except for the third, and fourth fifth protective films 208 and 209 formed with a target of ZnS with SiO₂ added at 40 mol % and 20 mol %, respectively.

Measurements in the same way as the embodiment sample E-51 revealed: 1.95 in refractive index n21 at the third protective film 208, 2.10 in refractive index n22 at the fourth protective film 209, and 1.78 in refractive index n23 at the fifth protective film 210, having a relation n22>n21>n23; and 5.9%, excellent in reflectivity at the second composite data-storage layer D2a.

### Comparative Sample C-51

The optical disc D20 in the comparative sample C-51 was identical to that of the embodiment sample E-51 except for the fourth and fifth protective films 209 and 210 formed with the same material as the third protective film 208.

Measurements in the same way as the embodiment sample E-51 revealed: 2.10 in all of the refractive indices n21, n22 and n23 at the third, fourth and fifth protective films 208, 209 and 210, respectively, having a relation n21=n22=n23; and 4.6%, bellow 5.0%, thus poor in reflectivity at the second composite data-storage layer D2a.

### Comparative Sample C-52

The optical disc D20 in the comparative sample C-52 was identical to that of the embodiment sample E-51 except for the fourth and fifth protective films 209 and 210 formed with a target of ZnS with SiO₂ added at 60 mol % and 40 mol %, respectively.

Measurements in the same way as the embodiment sample E-51 revealed: 2.10 in refractive index n21 at the third protective film 208, 1.78 in refractive index n22 at the fourth protective film 209, and 1.95 in refractive index n23 at the fifth protective film 210, having a relation n21>n23>n22; and 4.8%, poor in reflectivity at the second composite data-storage layer D2a.

### Comparative Sample C-53

The optical disc D20 in the comparative sample C-53 was identical to that of the embodiment sample E-51 except for the third, fourth and fifth protective films 208, 209 and 210 formed with a target of ZnS with SiO₂ added at 60 mol %, 20 mol % and 40 mol %, respectively.

Measurements in the same way as the embodiment sample E-51revealed: 1.78 in refractive index n21 at the third protective film 208, 2.10 in refractive index n22 at the fourth protective film 209, and 1.95 in refractive index n23 at the fifth protective film 210, having the relation n21>n23>n22; and 4.1%, poor in reflectivity at the second composite data-storage layer D2a.

### Comparative Sample C-54

The optical disc D20 in the comparative sample C-54 was identical to that of the embodiment sample E-51 except for the third, fourth and fifth protective films 208, 209 and 210 formed with a target of ZnS with SiO₂ added at 40 mol %, 60 mol % and 20 mol %, respectively.

Measurements in the same way as the embodiment sample E-51 revealed: 1.95 in refractive index n21 at the third protective film 208, 1.78 in refractive index n22 at the fourth protective film 209, and 2.10 in refractive index n23 at the fifth protective film 210, having a relation n23>n21>n22; and 3.7%, poor in reflectivity at the second composite data-storage layer D2a.

### Comparative Sample C-55

The optical disc D20 in the comparative sample C-55 was identical to that of the embodiment sample E-51 except for the third and fifth protective films 208 and 210 formed with a target of ZnS with SiO₂ added at 60 mol % and 20 mol %, respectively.

Measurements in the same way as the embodiment sample E-51 revealed: 1.78 in refractive index n21 at the third protective film 208, 1.95 in refractive index n22 at the fourth protective film 209, and 2.10 in refractive index n23 at the fifth protective film 210, having a relation n23>n22>n21; and 3.1%, poor in reflectivity at the second composite data-storage layer D2a.

The evaluation teaches that the relation n21>n22>n23 or n22>n21>n23 for the refractive index n21 at the third protective film 208, the refractive index n22 at the fourth protective film 209, and the refractive index n23 at the third protective film 210 gives excellent reflectivity to the second composite data-storage layer D2a, when the triple films 208, 209 and 210 are provided between the intermediate layer 207 and the second recording film 211 of the layer D2a. This is because the third, fourth and fifth protective films 208, 209 and 210 are sufficiently thin to the wavelength λ used in the measurements so that optical interference among the films enhances a laser beam of the wavelength λ, in the second embodiment.

The comparative sample C-51 was produced with the third, fourth and fifth protective films 208, 209 and 210 formed with the same material, substantially a single protective film, thus could not exhibit an excellent reflectivity at the second composite data-storage layer D2a.

The refractive indices n21, n22 and n23 were measured at 660 nm in wavelength λ in the second embodiment. The wavelength λ is, however, not limited to 660 nm. When the optical storage medium D20 is produced to exhibit the relation n21>n22>n23 or n22>n21>n23 to the wavelength λ in the range from 405 nm to 680 nm, a more excellent reflectivity is given to the second composite data-storage layer D2a.

[Study of Difference in Refractive Index among Third, Fourth and Fifth Protective Film]

The inventors of the present invention presupposed that the relation n21>n22>n23 or n22>n21>n23 in the refractive indices n21, n22 and n23 of the third, fourth and fifth protective films 208, 209 and 210, respectively, could have a specific range for the difference among the indices, for a more excellent reflectivity to the second composite data-storage layer D2a, and found out that the presumption is correct and then found out feasible differences among the refractive indices, according to the following measurements for new embodiment sample E-54 to E-60, and also new comparative samples C-56 and C-57.

Absolute values of differences between two refractive indices |n21−n22|, |n22−n23| and |n21−n23| are obtained as differences in refractive indices among n21, n22 and n23, and the smallest difference An among the three was used as an evaluation measure.

### Embodiment Sample E-54

The optical disc D20 in the embodiment sample E-54 was identical to that of the embodiment sample E-1 except for the fourth and fifth protective films 209 and 210 formed with a target of ZnS with SiO₂ added at 30 mol % and 40 mol %, respectively.

Measurements in the same way as the embodiment sample E-51 revealed: 2.10 in refractive index n21 at the third protective film 208, 2.02 in refractive index n22 at the fourth protective film 209, and 1.95 in refractive index n22 at the fifth protective film 220, satisfying the relation n21>n22>n23; 0.07 in difference in refractive index Δn in ↑n21−n22| (smaller than |n22−n23| and |n21−n23|); and 5.9%, excellent in reflectivity at the second composite data-storage layer D2a.

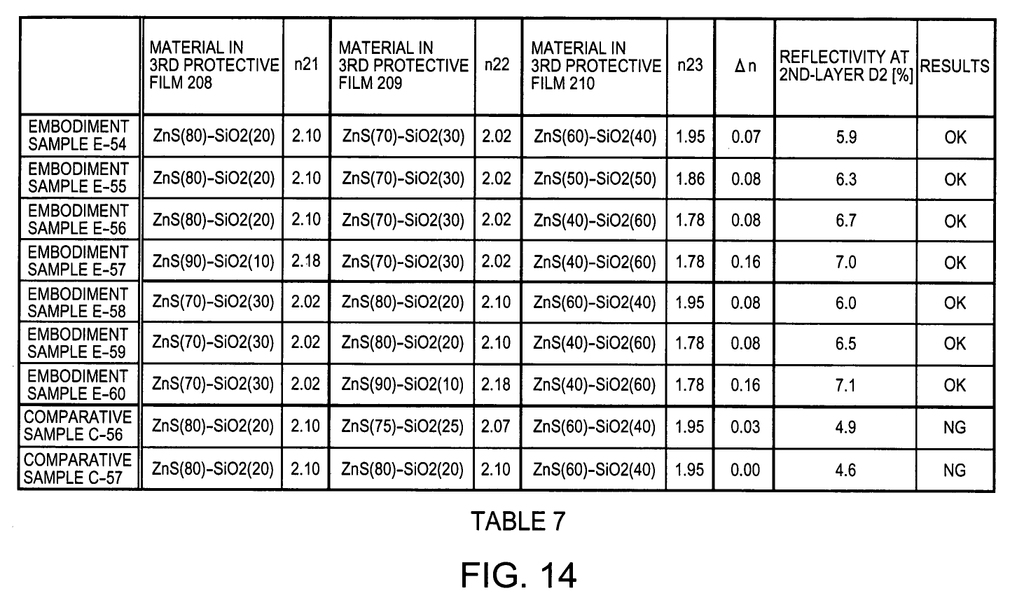

The measured results for the embodiment sample E-54 are listed in TABLE 7 of FIG. 14, together with those for the embodiment samples E-55 to E-60, and the comparative samples C-56 and C-57.

### Embodiment Sample E-55

The optical disc D20 in the embodiment sample E-55 was identical to that of the embodiment sample E-54 except for the fifth protective film 210 formed with a target of ZnS with SiO₂ added at 50 mol %.

Measurements in the same way as the embodiment sample E-54 revealed: the relation n21>n22>n23 satisfied among the refractive indices n21, n22 and n23; 0.08 in difference in refractive index Δn (|n21−n22|); and 6.3%, excellent in reflectivity at the second composite data-storage layer D2a.

### Embodiment Sample E-56

The optical disc D20 in the embodiment sample E-56 was identical to that of the embodiment sample E-54 except for the fifth protective film 210 formed with a target of ZnS with SiO₂ added at 60 mol %.

Measurements in the same way as the embodiment sample E-54 revealed: n21>n22>n23 satisfied; 0.08 in difference in refractive index Δn (|n21−n22|); and 6.7%, excellent in reflectivity at the second composite data-storage layer D2a.

### Embodiment Sample E-57

The optical disc D20 in the embodiment sample E-57 was identical to that of the embodiment sample E-54 except for the third and fifth protective films 208 and 210 formed with a target of ZnS with SiO₂ added at 10 mol % and 60 mol %, respectively.

Measurements in the same way as the embodiment sample E-54 revealed: n21>n22>n23 satisfied; 0.16 in difference in refractive index Δn (|n21−n22|); and 7.0%, excellent in reflectivity at the second composite data-storage layer D2a.

### Embodiment Sample E-58

The optical disc D20 in the embodiment sample E-58 was identical to that of the embodiment sample E-54 except for the third and fourth protective films 208 and 209 formed with a target of ZnS with SiO₂ added at 30 mol % and 20 mol %, respectively.

Measurements in the same way as the embodiment sample E-54 revealed: n22>n21>n23 satisfied; 0.08 in difference in refractive index Δn (|n21−n22|); and 6.0%, excellent in reflectivity at the second composite data-storage layer D2a.

### Embodiment Sample E-59

The optical disc D20 in the embodiment sample E-59 was identical to that of the embodiment sample E-54 except for the third, fourth and fifth protective films 208, 209 and 210 formed with a target of ZnS with SiO₂ added at 30 mol %, 20 mol % and 60 mol %, respectively.

Measurements in the same way as the embodiment sample E-54 revealed: n22>n21>n23 satisfied; 0.08 in difference in refractive index Δn (|n21−n22|); and 6.5%, excellent in reflectivity at the second composite data-storage layer D2a.

### Embodiment Sample E-60

The optical disc D20 in the embodiment sample E-60 was identical to that of the embodiment sample E-54 except for the third, fourth and fifth protective films 208, 209 and 210 formed with a target of ZnS with SiO₂ added at 30 mol %, 10 mol % and 60 mol %, respectively.

Measurements in the same way as the embodiment sample E-54 revealed: n22>n21>n23 satisfied; 0.16 in difference in refractive index Δn (|n21−n22|); and 7.1%, excellent in reflectivity at the second composite data-storage layer D2a.

### Comparative Sample C-56

The optical disc D20 in the comparative sample C-56 was identical to that of the embodiment sample E-54 except for the fourth protective film 209 formed with a target of ZnS with SiO₂ added at 25 mol %.

Measurements in the same way as the embodiment sample E-54 revealed: n21>n22>n23 satisfied; 0.03 in difference in refractive index Δn (|n21−n22|); but 4.9%, poor in reflectivity at the second composite data-storage layer D2a.

### Comparative Sample C-57

The optical disc D20 in the comparative sample C-57 was identical to that of the embodiment sample E-54 except for the fourth protective film 209 formed with a target of ZnS with SiO₂ added at 20 mol %.

Measurements in the same way as the embodiment sample E-54 revealed: a relation n21=n22>n23 shown for the refractive indices n21, n22 and n23; 0.00 in difference in refractive index Δn (|n21−n22|); and 4.6%, poor in reflectivity at the second composite data-storage layer D2a.

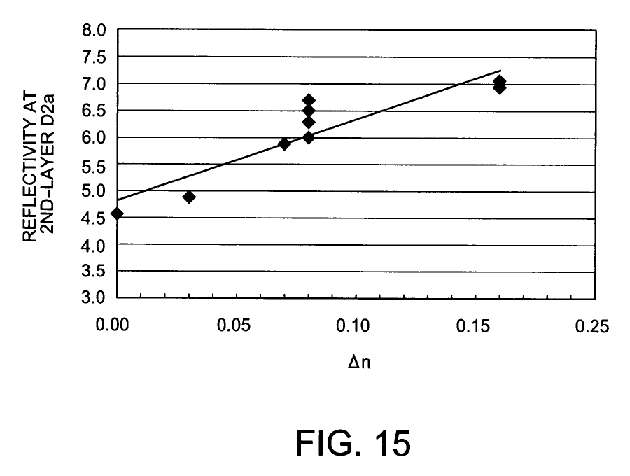

FIG. 15 shows change in reflectivity at the second composite data-storage layer D2a depending on the difference in refractive index Δn, based on the results in TABLE 7. It teaches that the difference in refractive index Δn of 0.01 or larger gives the reflectivity of 5.0% or higher to the second composite data-storage layer D2a. A possible reason for this is that the third, fourth and fifth protective films 208, 209 and 210 optically interfere with each other to the wavelength λ of a laser beam, thus giving higher reflectivity. A refractive index Δn of 0.08 or larger is feasible in giving an excellent reflectivity for a larger production margin.

The refractive indices n21, n22 and n23 were also measured at 660 nm in wavelength λ in the samples discussed above. The wavelength λ is, however, not limited to 660 nm. When the optical storage medium D20 is produced to exhibit the relation discussed above for the indices n21, n22 and n23 to the wavelength λ in the range from 405 nm to 680 nm, a more excellent reflectivity is given to the second composite data-storage layer D2a.

[Study of Thickness in Third, Fourth and Fifth Protective Film]

The inventors of the present invention further presupposed that the total thickness (d21+d22+d23) of a thickness d21 of the third protective film 208, a thickness d22 of the fourth protective film 209, and a thickness d23 of the fifth protective film 210 could have a specific relation with a wavelength λ of a laser beam in recording, reproduction or erasure, for excellent reflectivity to the second composite data-storage layer D2a, and found out a specific range for an optical path length (d21+d22+d23)/λ, according to the following measurements for the embodiment E-51, new embodiment samples E-61 to E-71, and also new comparative samples C-58 to C-73.

### Embodiment Sample E-61

The optical disc D20 in the embodiment sample E-61 was identical to that of the embodiment sample E-51 except for the third protective film 208 having a thickness d21 of 40 nm, the fourth protective film 209 having a thickness d22 of 40 nm, and the fifth protective film 210 having a thickness d23 of 40 nm.

Measurements in the same way as the embodiment sample E-51 revealed: 2.10 in refractive index n21 at the third protective film 208, 1.95 in refractive index n22 at the fourth protective film 209, and 1.78 in refractive index n23 at the third protective film 210, satisfying the relation n21>n22>n23; and 5.53%, excellent in reflectivity at the second composite data-storage layer D2a.

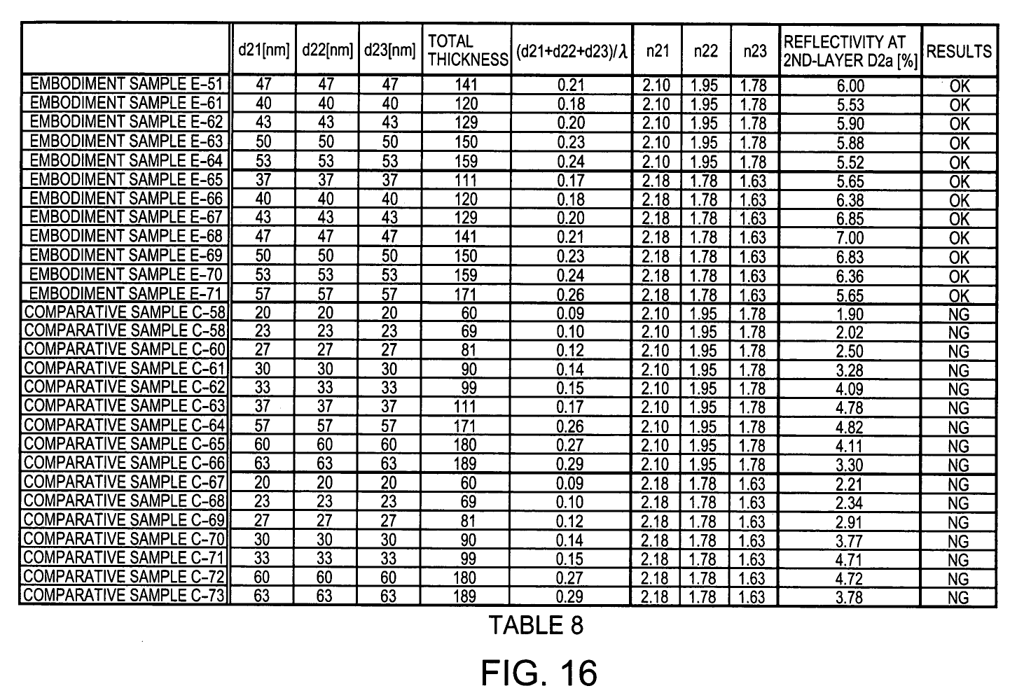

The measured results for the embodiment sample E-61 are listed in TABLE 8 of FIG. 16, together with those for the embodiment samples E-62 to E-71 and the comparative samples C-58 to C-73.

### Embodiment Sample E-62

The optical disc D20 in the embodiment sample E-62 was identical to that of the embodiment sample E-51 except for the third protective film 208 having a thickness d21 of 43 nm, the fourth protective film 209 having a thickness d22 of 43 nm, and the fifth protective film 210 having a thickness d23 of 43 nm.

Measurements in the same way as the embodiment sample E-51 revealed: n21>n22>n23 satisfied; and 5.90%, excellent in reflectivity at the second composite data-storage layer D2a.

### Embodiment Sample E-63

The optical disc D20 in the embodiment sample E-63 was identical to that of the embodiment sample E-51 except for the third protective film 208 having a thickness d21 of 50 nm, the fourth protective film 209 having a thickness d22 of 50 nm, and the fifth protective film 210 having a thickness d23 of 50 nm.

Measurements in the same way as the embodiment sample E-51 revealed: n21>n22>n23 satisfied; and 5.88%, excellent in reflectivity at the second composite data-storage layer D2a.

### Embodiment Sample E-64

The optical disc D20 in the embodiment sample E-64 was identical to that of the embodiment sample E-51 except for the third protective film 208 having a thickness d21 of 53 nm, the fourth protective film 209 having a thickness d22 of 53 nm, and the fifth protective film 210 having a thickness d23 of 53 nm.

Measurements in the same way as the embodiment sample E-51 revealed: n21>n22>n23 satisfied; and 5.52%, excellent in reflectivity at the second composite data-storage layer D2a.

### Embodiment Sample E-65

The optical disc D20 in the embodiment sample E-64 was identical to that of the embodiment sample E-51 except for the third protective film 208 having a thickness d21 of 37 nm formed with a target of ZnS with SiO₂ added at 10 mol %, the fourth protective film 209 having a thickness d22 of 37 nm formed with a target of ZnS with SiO₂ added at 60 mol %, and the fifth protective film 210 having a thickness d23 of 37 nm formed with a target of ZnS with SiO₂ added at 80 mol %.

Measurements in the same way as the embodiment sample E-51 revealed: n21>n22>n23 satisfied; and 5.65%, excellent in reflectivity at the second composite data-storage layer D2a.

### Embodiment Sample E-66

The optical disc D20 in the embodiment sample E-66 was identical to that of the embodiment sample E-65 except for the third protective film 208 having a thickness d21 of 40 nm, the fourth protective film 209 having a thickness d22 of 40 nm, and the fifth protective film 210 having a thickness d23 of 40 nm.

Measurements in the same way as the embodiment sample E-65 revealed: n21>n22>n23 satisfied; and 6.38%, excellent in reflectivity at the second composite data-storage layer D2a.

### Embodiment Sample E-67

The optical disc D20 in the embodiment sample E-67 was identical to that of the embodiment sample E-65 except for the third protective film 208 having a thickness d21 of 43 nm, the fourth protective film 209 having a thickness d22 of 43 nm, and the fifth protective film 210 having a thickness d23 of 43 nm.

Measurements in the same way as the embodiment sample E-65 revealed: n21>n22>n23 satisfied; and 6.85%, excellent in reflectivity at the second composite data-storage layer D2a.

### Embodiment Sample E-68

The optical disc D20 in the embodiment sample E-68 was identical to that of the embodiment sample E-65 except for the third protective film 208 having a thickness d21 of 47 nm, the fourth protective film 209 having a thickness d22 of 47 nm, and the fifth protective film 210 having a thickness d23 of 47 nm.

Measurements in the same way as the embodiment sample E-65 revealed: n21>n22>n23 satisfied; and 7.00%, excellent in reflectivity at the second composite data-storage layer D2a.

### (Embodiment Sample E-69

The optical disc D20 in the embodiment sample E-69 was identical to that of the embodiment sample E-65 except for the third protective film 208 having a thickness d21 of 50 nm, the fourth protective film 209 having a thickness d22 of 50 nm, and the fifth protective film 210 having a thickness d23 of 50 nm.

Measurements in the same way as the embodiment sample E-65 revealed: n21>n22>n23 satisfied; and 6.83%, excellent in reflectivity at the second composite data-storage layer D2a.

### Embodiment Sample E-70

The optical disc D20 in the embodiment sample E-70 was identical to that of the embodiment sample E-65 except for the third protective film 208 having a thickness d21 of 53 nm, the fourth protective film 209 having a thickness d22 of 53 nm, and the fifth protective film 210 having a thickness d23 of 53 nm.

Measurements in the same way as the embodiment sample E-65 revealed: n21>n22>n23 satisfied; and 6.36%, excellent in reflectivity at the second composite data-storage layer D2a.

### Embodiment Sample E-71

The optical disc D20 in the embodiment sample E-71 was identical to that of the embodiment sample E-65 except for the third protective film 208 having a thickness d21 of 57 nm, the fourth protective film 209 having a thickness d22 of 57 nm, and the fifth protective film 210 having a thickness d23 of 57 nm.

Measurements in the same way as the embodiment sample E-65 revealed: n21>n22>n23 satisfied; and 5.65%, excellent in reflectivity at the second composite data-storage layer D2a.

### Comparative Sample C-58

The optical disc D20 in the comparative sample C-58 was identical to that of the embodiment sample E-51 except for the third protective film 208 having a thickness d21 of 20 nm, the fourth protective film 209 having a thickness d22 of 20 nm, and the fifth protective film 210 having a thickness d23 of 20 nm.

Measurements in the same way as the embodiment sample E-51 revealed: the relation n21>n22>n23 satisfied; but 1.90%, poor in reflectivity at the second composite data-storage layer D2a.

### Comparative Sample C-59

The optical disc D20 in the comparative sample C-59 was identical to that of the embodiment sample E-51 except for the third protective film 208 having a thickness d21 of 23 nm, the fourth protective film 209 having a thickness d22 of 23 nm, and the fifth protective film 210 having a thickness d23 of 23 nm.

Measurements in the same way as the embodiment sample E-51 revealed: n21>n22>n23 satisfied; but 2.02 %, poor in reflectivity at the second composite data-storage layer D2a.

### Comparative Sample C-60

The optical disc D20 in the comparative sample C-60 was identical to that of the embodiment sample E-51 except for the third protective film 208 having a thickness d21 of 27 nm, the fourth protective film 209 having a thickness d22 of 27 nm, and the fifth protective film 210 having a thickness d23 of 27 nm.

Measurements in the same way as the embodiment sample E-51 revealed: the relation n21>n22>n23 satisfied; but 2.50%, poor in reflectivity at the second composite data-storage layer D2a.

### Comparative Sample C-61

The optical disc D20 in the comparative sample C-61 was identical to that of the embodiment sample E-51 except for the third protective film 208 having a thickness d21 of 30 nm, the fourth protective film 209 having a thickness d22 of 30 nm, and the fifth protective film 210 having a thickness d23 of 30 nm.

Measurements in the same way as the embodiment sample E-51 revealed: n21>n22>n23 satisfied; but 3.28%, poor in reflectivity at the second composite data-storage layer D2a.

### Comparative Sample C-62

The optical disc D20 in the comparative sample C-62 was identical to that of the embodiment sample E-51 except for the third protective film 208 having a thickness d21 of 33 nm, the fourth protective film 209 having a thickness d22 of 33 nm, and the fifth protective film 210 having a thickness d23 of 33 nm.

Measurements in the same way as the embodiment sample E-51 revealed: n21>n22>n23 satisfied; but 4.09%, poor in reflectivity at the second composite data-storage layer D2a.

### Comparative Sample C-63

The optical disc D20 in the comparative sample C-63 was identical to that of the embodiment sample E-51 except for the third protective film 208 having a thickness d21 of 37 nm, the fourth protective film 209 having a thickness d22 of 37 nm, and the fifth protective film 210 having a thickness d23 of 37 nm.

Measurements in the same way as the embodiment sample E-51 revealed: n21>n22>n23 satisfied; but 4.78%, poor in reflectivity at the second composite data-storage layer D2a.

### Comparative Sample C-64

The optical disc D20 in the comparative sample C-64 was identical to that of the embodiment sample E-51 except for the third protective film 208 having a thickness d21 of 57 nm, the fourth protective film 209 having a thickness d22 of 57 nm, and the fifth protective film 210 having a thickness d23 of 57 nm.

Measurements in the same way as the embodiment sample E-51 revealed: n21>n22>n23 satisfied; but 4.82%, poor in reflectivity at the second composite data-storage layer D2a.

### Comparative Sample C-65

The optical disc D20 in the comparative sample C-65 was identical to that of the embodiment sample E-51 except for the third protective film 208 having a thickness d21 of 60 nm, the fourth protective film 209 having a thickness d22 of 60 nm, and the fifth protective film 210 having a thickness d23 of 60 nm.

Measurements in the same way as the embodiment sample E-51 revealed: n21>n22>n23 satisfied; but 4.11%, poor in reflectivity at the second composite data-storage layer D2a.

### Comparative Sample C-66

The optical disc D20 in the comparative sample C-65 was identical to that of the embodiment sample E-51 except for the third protective film 208 having a thickness d21 of 63 nm, the fourth protective film 209 having a thickness d22 of 63 nm, and the fifth protective film 210 having a thickness d23 of 63 nm.

Measurements in the same way as the embodiment sample E-51 revealed: n21>n22>n23 satisfied; but 3.30%, poor in reflectivity at the second composite data-storage layer D2a.

### Comparative Sample C-67

The optical disc D20 in the comparative sample C-67 was identical to that of the embodiment sample E-65 except for the third protective film 208 having a thickness d21 of 20 nm, the fourth protective film 209 having a thickness d22 of 20 nm, and the fifth protective film 210 having a thickness d23 of 20 nm.

Measurements in the same way as the embodiment sample E-65 revealed: n21>n22>n23 satisfied; but 2.21%, poor in reflectivity at the second composite data-storage layer D2a.

### Comparative Sample C-68

The optical disc D20 in the comparative sample C-68 was identical to that of the embodiment sample E-65 except for the third protective film 208 having a thickness d21 of 23 nm, the fourth protective film 209 having a thickness d22 of 23 nm, and the fifth protective film 210 having a thickness d23 of 23 nm.

Measurements in the same way as the embodiment sample E-65 revealed: n21>n22>n23 satisfied; but 2.34%, poor in reflectivity at the second composite data-storage layer D2a.

### Comparative Sample C-69

The optical disc D20 in the comparative sample C-69 was identical to that of the embodiment sample E-65 except for the third protective film 208 having a thickness d21 of 27 nm, the fourth protective film 209 having a thickness d22 of 27 nm, and the fifth protective film 210 having a thickness d23 of 27 nm.

Measurements in the same way as the embodiment sample E-65 revealed: n21>n22>n23 satisfied; but 2.91%, poor in reflectivity at the second composite data-storage layer D2a.

### Comparative Sample C-70

The optical disc D20 in the comparative sample C-70 was identical to that of the embodiment sample E-65 except for the third protective film 208 having a thickness d21 of 30 nm, the fourth protective film 209 having a thickness d22 of 30 nm, and the fifth protective film 210 having a thickness d23 of 30 nm.

Measurements in the same way as the embodiment sample E-65 revealed: n21>n22>n23 satisfied; but 3.77%, poor in reflectivity at the second composite data-storage layer D2a.

### Comparative Sample C-71

The optical disc D20 in the comparative sample C-71 was identical to that of the embodiment sample E-65 except for the third protective film 208 having a thickness d21 of 33 nm, the fourth protective film 209 having a thickness d22 of 33 nm, and the fifth protective film 210 having a thickness d23 of 33 nm.

Measurements in the same way as the embodiment sample E-65 revealed: n21>n22>n23 satisfied; but 4.71%, poor in reflectivity at the second composite data-storage layer D2a.

### Comparative Sample C-72

The optical disc D20 in the comparative sample C-72 was identical to that of the embodiment sample E-65 except for the third protective film 208 having a thickness d21 of 60 nm, the fourth protective film 209 having a thickness d22 of 60 nm, and the fifth protective film 210 having a thickness d23 of 60 nm.

Measurements in the same way as the embodiment sample E-65 revealed: n21>n22>n23 satisfied; but 4.72%, poor in reflectivity at the second composite data-storage layer D2a.

### Comparative Sample C-73

The optical disc D20 in the comparative sample C-73 was identical to that of the embodiment sample E-65 except for the third protective film 208 having a thickness d21 of 63 nm, the fourth protective film 209 having a thickness d22 of 63 nm, and the fifth protective film 210 having a thickness d23 of 63 nm.

Measurements in the same way as the embodiment sample E-65 revealed: n21>n22>n23 satisfied; but 3.78%, poor in reflectivity at the second composite data-storage layer D2a.

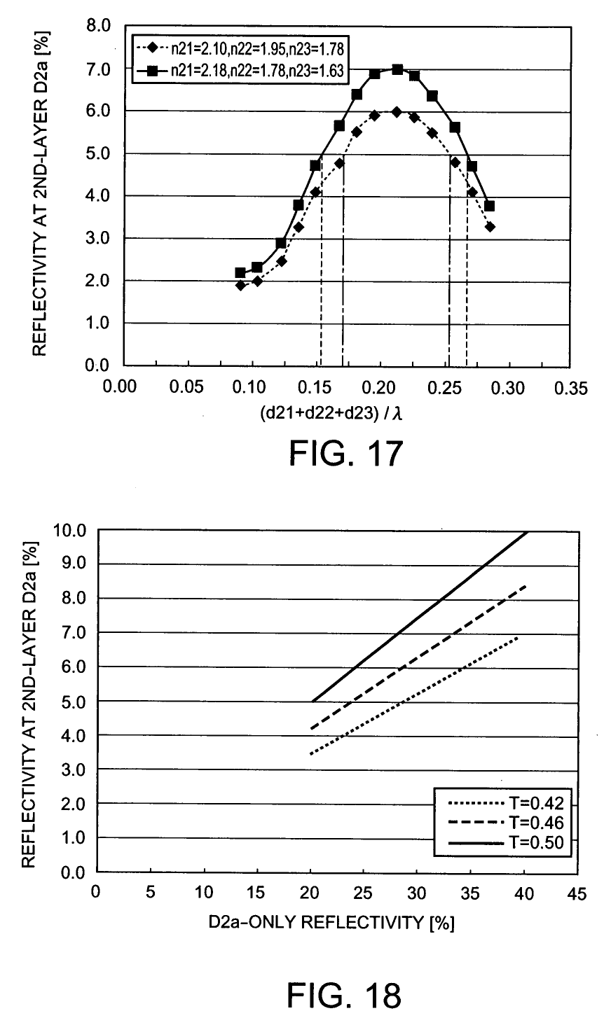

FIG. 17 shows change in reflectivity at the second composite data-storage layer D2a depending on the optical path length (d21+d22+d23)/λ, based on the results shown in TABLE 8.

FIG. 17 teaches that (d21+d22+d23)/λ in the range from 0.17 to 0.26 gives the reflectivity of 5.0% or higher to the second composite data-storage layer D2a for the embodiment samples E-51, E-61 to E-64 each exhibiting the refractive index n21 of 2.10 at the third protective film 208, the refractive index n22 of 1.95 at the fourth protective film 209, and the refractive index n23 of 1.78 at the fifth protective film 210.

The comparative samples C-58 to C-66 each exhibiting the refractive index n21 of 2.10 at the third protective film 208, the refractive index n22 of 1.95 at the fourth protective film 209, and the refractive index n23 of 1.78 at the fifth protective film 210 could have exhibited 5.0% or higher in reflectivity at the second composite data-storage layer D2a if the optical path length (d21+d22+d23)/λ were in the range mentioned above.

FIG. 17 also teaches that (d21+d22+d23)/λ in the range from 0.15 to 0.27 gives the reflectivity of 5.0% or higher to the second composite data-storage layer D2a for the embodiment samples E-65 to E-71 each exhibiting the refractive index n21 of 2.18 at the third protective film 208, the refractive index n22 of 1.78 at the fourth protective film 209, and the refractive index n23 of 1.63 at the fifth protective film 210.

The comparative samples C-67 to C-73 each exhibiting the refractive index n21 of 2.18 at the third protective film 208, the refractive index n22 of 1.78 at the fourth protective film 209, and the refractive index n23 of 1.63 at the fifth protective film 210 could have exhibited 5.0% or higher in reflectivity at the second composite data-storage layer D2a if the optical path length (d21+d22+d23)/λ were in the range mentioned above.

Accordingly, in each combination of the refractive indices n21, n22 and n23 described above, (d21+d22+d23)/λ in the range from 0.17 to 0.26 gives excellent reflectivity to the second composite data-storage layer D2a. A more preferable range is from 0.18 to 0.24 for further excellent reflectivity.

A laser beam of 660 nm in wavelength λ was used in finding the optical path length (d21+d22+d23)/λ that gives excellent reflectivity to the second composite data-storage layer D2a, in these samples. The wavelength λ is, however, not limited to 660 nm. When the optical storage medium D20 is produced to have (d21+d22+d23)/λ in the range from 0.17 to 0.26, a more excellent reflectivity is given to the second composite data-storage layer D2a.

TABLE 8 teaches the total thickness (d21+d22+d23) of 110 nm or more for the third, fourth and fifth protective films 208, 209 and 210 gives excellent reflectivity to the second composite data-storage layer D2a. This is, however, comparatively thick, and hence, a material of a higher sputtering rate is preferable for the films 208, 209 and 210 for higher mass productivity.

The material, refractive index and sputtering rate are examined for the third, fourth and fifth protective films 208, 209 and 210, based on TABLE 5, already shown in FIG. 10.

TABLE 5 teaches that a mixture of ZnS and SiO₂ can only be sputtered at a sputtering rate closer 1.0 whereas the other materials (SiO₂, SiC, TiO₂, SiH, GeN, ZnO, ZrO₂ and Nb₂O₅) at much smaller rates, as already discussed. The materials except ZnS—SiO₂ are thus not useful for mass production due to their slower sputtering rates.

Therefore, the optical storage medium D20 is required to be produced with ZnS—SiO₂ for the third, fourth and fifth protective films 208, 209 and 210 so that the films 208, 209 and 210 exhibit the refractive indices n21, n22 and n23, respectively, having the relation discussed above, for excellent reflectivity at the second composite data-storage layer D2a, with higher mass productivity.

As shown in FIG. 11, a higher molar ratio Of SiO₂ gives a smaller reflectivity n (n21, n22 and n23), particularly, the ratio over 0.8 causes a slower sputtering rate, thus not feasible for mass production.

Accordingly, higher reflectivity is given to the second composite data-storage layer D2a when the third protective film 208 is formed with a material including at least ZnS, optionally with SiO₂ at a molar ratio α1 of 0<α1≦0.8, the fourth protective film 209 with a material including at least ZnS, optionally with SiO₂ at a molar ratio α2 of 0<α2≦0.8, and the fifth protective film 210 with a material including at least ZnS and SiO₂ with a molar ratio α3 of 0<α3≦0.8 for SiO₂.

FIG. 18 shows change in reflectivity at the second composite data-storage layer D2a depending on D2a-only reflectivity. The D2a-only reflectivity is the reflectivity at the layer D2a provided between the first and second substrates 201 and 214 with no first composite data-storage layer D1a and intermediate layer 207 between the substrate 201 and the layer D2a, in the optical storage medium D20 shown in FIG. 2.

The several films of the second composite data-storage layer D2a were modified so that the layer D2a exhibited different light transmittances T (0.42, 0.46, and 0.50). The D2a-only reflectivity was increased at each transmittance T and measured by an optical-disc drive tester (DDU-1000) made by Pulstec Industrial Co. Ltd.

Sample optical storage media D20 (the second embodiment) were produced with the modified second composite data-storage layers D2a that exhibited light transmittances T (0.42, 0.46, and 0.50).

The first composite data-storage layer D1a in the second embodiment exhibits about 0.43 in transmittance T to a laser beam having a wavelength λ of 660 nm.

FIG. 18 shows that the modified second composite data-storage layers D2a exhibited the reflectivity of 5.0% or higher to the D2a-only reflectivity of 28.0% or higher, at the corresponding transmittances T (0.42, 0.46, and 0.50).

Accordingly, a preferable reflectivity is 28.0% or higher for the second composite data-storage layer D2a located farther from the beam-incident surface 201A, in the optical storage media D20 of the second embodiment.

As discussed above, several factors are examined for the multilayer phase-change optical storage medium D (D20) having two or more of composite data-storage layers, in the present invention.

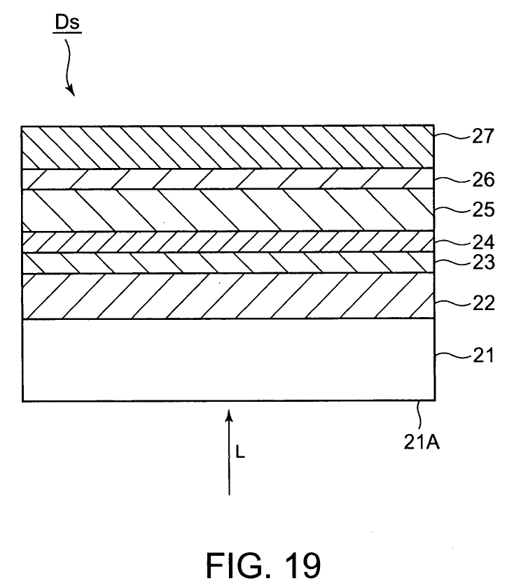

Not only such multilayer phase-change optical storage media, the present invention achieves higher reflectivity for a single-layer phase-change optical storage medium Ds, such as shown in FIG. 19, when the medium Ds is formed as having the relations discussed above for the third and fourth protective films 8 and 9 of the optical storage medium D.

The optical storage medium Ds shown in FIG. 19 has a first protective film 22, a second protective film 23, a recording film 24, a third protective film 25, and a reflective film 26 are laminated in order on a substrate 21 (with a fourth protective film 27 applied on the film 26) having a bottom surface that is a light-incident surface 21A on which a laser beam is incident in a direction L in recording, reproduction or erasure.

The first and second protective films 22 and 23 (medium Ds) correspond to the third and fourth protective films 8 and 9 (medium D), respectively. Thus, the requirement for a higher reflectivity for the optical storage medium Ds is that the films 22 and 23 satisfy the relation between their refractive indices n12 and n13, respectively, the same as that for the refractive indices n1 and n2 of the films 8 and 9, respectively.

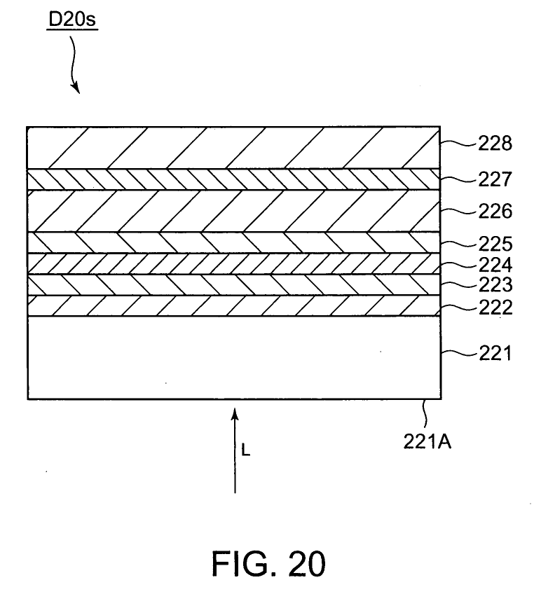

Moreover, the present invention achieves higher reflectivity for a single-layer phase-change optical storage medium D20s, such as shown in FIG. 20, when the medium D20s is formed as having the relations discussed above for the third, fourth and fifth protective films 208, 209 and 210 of the optical storage medium D20.

The optical storage medium D20s shown in FIG. 20 has a first protective film 222, a second protective film 223, a third protective film 224, a recording film 225, a fourth protective film 226, and a reflective film 227 are laminated in order on a substrate 221 (a fifth protective film 228 applied on the film 227) having a bottom surface that is a light-incident surface 221A on which a laser beam is incident in a direction L in recording, reproduction or erasure.

The first, second and third protective films 222, 223 and 224 (medium D20s) correspond to the third, fourth and fifth protective films 208, 209 and 210 (medium D20), respectively. Thus, the requirement for a higher reflectivity for the optical storage medium D20s is that the films 222, 223 and 224 satisfy the relation among their refractive indices n222, n223 and n224, respectively, the same as that for the refractive indices n21, n22 and n23 of the films 208, 209 and 210.

As disclosed above in detail, the present invention achieves higher reflectivity at a composite data-storage layer (data-storage layers) located far from the light-incident surface in a multilayer phase-change optical storage medium having a plurality of data-storage layers, with high mass productivity.

Furthermore, the present invention achieves higher reflectivity for a phase-change optical storage medium having at least one composite data-storage layer.

What is claimed is:

1. An optical storage medium comprising:
a substrate having a first surface and a second surface on both sides, the first surface allowing light to pass therethrough in recording or reproduction; and
at least one composite layer having at least a first protective film, a second protective film and a recording film formed in order on the second surface, the first and second protective films exhibiting refractive indices n1 and n2, respectively, having the following relations therebetween, to the light having a specific wavelength λ:
n1>n2 (1)
n1−n2≧0.02 (2)
2.1≦n1≦2.5, 1.5≦n2<2.1 (3).

2. The optical storage medium according to claim 1, wherein the specific wavelength λ is in the range from 405 nm to 680 nm.

3. The optical storage medium according to claim 1, wherein the first and second protective films have thicknesses d1 and d2, respectively, having a relation 0.17≦(d1+d2)/λ≦0.25 with the specific wavelength λ.

4. The optical storage medium according to claim 1, wherein the first protective film is formed with a material including at least ZnS and the second protective film is formed with a material including at least ZnS and SiO₂.

5. The optical storage medium according to claim 1, wherein the first protective film is formed with a material including at least ZnS and SiO₂ with a molar ratio α1 of 0<α1≦0.2 for SiO₂ and the second protective film is formed with a material including at least ZnS and SiO₂ with a molar ratio α2 of 0.3≦α2≦0.8 for SiO₂.

6. The optical storage medium according to claim 1 further comprising another composite layer that is located closer than the one composite layer to the second surface, the one composite layer exhibiting a reflectivity of 28% or higher to the specific wavelength α.

7. An optical storage medium comprising:
a substrate having a first surface and a second surface on both sides, the first surface allowing light to pass therethrough in recording or reproduction; and
at least one composite layer having at least a first protective film, a second protective film, a third protective film and a recording film formed in order on the second surface, the first, second and third protective films exhibiting refractive indices n21, n22 and n23, respectively, having either of the following relations thereamong, to the light having a specific wavelength λ:
n21>n22>n23 (1)
n22>n21>n23 (2).

8. The optical storage medium according to claim 7, wherein the specific wavelength λ is in the range from 405 nm to 680 nm.

9. The optical storage medium according to claim 7, wherein the smallest difference Δn among absolute values of differences between two refractive indices |n21−n22|, |n22−n23| and |n21−n23| is 0.01 or larger.

10. The optical storage medium according to claim 7, wherein the first, second and third protective films have thicknesses d21, d22 and d23, respectively, having a relation 0.17≦(d21+d22+d23)/λ≦0.26 with the specific wavelength λ.

11. The optical storage medium according to claim 7, wherein the first and second protective films are formed with a material including at least ZnS and the third protective film is formed with a material including at least ZnS and SiO₂.

12. The optical storage medium according to claim 7, wherein each of the first, second and third protective film is formed with a material including at least ZnS and SiO₂ with a molar ratio a of 0<α<0.8 for SiO₂.

13. The optical storage medium according to claim 7 further comprising another composite layer that is located closer than the one composite layer to the second surface, the one composite layer exhibiting a reflectivity of 28% or higher to the specific wavelength λ.
